(19) United States
(12) Patent Application Publication
(10) Pub. No.: US 2026/0209063 A1
(43) Pub. Date: Jul. 23, 2026

(54) NOVEL COMPOSITE OXIDE AND OXYGEN STORAGE MATERIAL CONTAINING THE SAME

(71) Applicant: TOYOTA JIDOSHA KABUSHIKI KAISHA, Toyota-shi (JP)

(72) Inventors: Yoshio OHASHI, Gotemba-shi (JP); Naoto NAGATA, Gotemba-shi (JP)

(73) Assignee: TOYOTA JIDOSHA KABUSHIKI KAISHA, Toyota-shi (JP)

(21) Appl. No.: 19/446,348

(22) Filed: Jan. 12, 2026

(30) Foreign Application Priority Data
Jan. 17, 2025 (JP) 2025-006587
Apr. 24, 2025 (JP) 2025-072429

(51) Int. Cl. C01F 17/32

(52) U.S. Cl. CPC C01F 17/32; C01P 2002/30; C01P 2002/72; C01P 2002/88

(57) ABSTRACT

Provided is an inexpensive oxygen storage material having an excellent oxygen release performance at low temperature. One aspect of the present disclosure relates to a composite oxide having a composition represented by a general formula Ce_{2-w-x′}A_{w}A′_{x′}B_{1-y′-z}B′_{y′}B″_{z}O_{6-w/2-x′-y′/2-z}. In the formula, A is one or more elements selected from rare-earth metal elements excluding Ce, A′ is one or more elements selected from alkaline earth metal elements, B is one or more elements selected from the group consisting of Ti and Group 14 elements, B′ is one or more elements selected from the group consisting of Group 13 elements, B″ is one or more elements selected from the group consisting of Group 12 elements, 2−w−x′, w, x′, 1−y′−z, y′, z, and 6−w/2−x′−y′/2−z are mole ratios of Ce, A, A′, B, B′, B″, and O, respectively when B+B′+B″ is assumed to be 1, w, x′, y′, and z satisfy 0≤w<2, 0≤x′<0.5, 0≤y′≤1, 0≤z≤0.5, respectively, and w+x′ satisfies 0≤w+x′<2, and y′+z satisfies 0≤y′+z≤1.

### CROSS REFERENCE TO RELATED APPLICATIONS

The present application claims priority from Japanese patent applications JP 2025-006587 filed on Jan. 17, 2025 and JP 2025-072429 filed on Apr. 24, 2025, the entire content of which is hereby incorporated by reference into this application.

### BACKGROUND

### Technical Field

One aspect of the present disclosure relates to a novel composite oxide and an oxygen storage material containing the same.

### Background Art

An exhaust gas emitted from an internal combustion engine of an automobile and the like contains harmful components, such as carbon monoxide (CO), hydrocarbon (HC), and nitrogen oxide (NOₓ), and the harmful components are removed by an exhaust gas purification catalyst and then released into the atmosphere. Conventionally, a three-way catalyst that simultaneously oxidizes CO, HC and reduces NOₓ is used for the exhaust gas purification catalyst. As the three-way catalyst, a porous oxide carrier such as alumina (Al₂O₃), silica (SiO₂), zirconia (ZrO₂), and titania (TiO₂) on which noble metals such as platinum (Pt), palladium (Pd), and rhodium (Rh) are supported is widely used.

In recent years, an oxygen storage material, which is an inorganic material having an oxygen storage capacity (OSC performance), has been used for the exhaust gas purification catalyst in order to enhance an exhaust gas purification ability of the three-way catalyst in response to variations in oxygen concentration in the exhaust gas. Ceria (CeO₂) is known to have an excellent OSC performance and is widely used as an oxygen storage material in the form of ceria-zirconia composite oxide (CeO₂—ZrO₂).

As an oxygen storage material of such a ceria-zirconia composite oxide, for example, JP 2009-84061 A discloses a ceria-zirconia-based composite oxide containing a composite oxide of ceria and zirconia, in which a pyrochlore phase-type ordered array phase is formed by cerium ions and zirconium ions in the composite oxide, and 50% or more of the pyrochlore phase-type ordered array phase remains after heating in the air under a temperature condition of 1000° C. for 5 hours as compared with that before heating.

JP 2018-131365 A discloses an oxygen storage material that contains a ceria-zirconia-titania-based composite oxide containing cerium, zirconium, and titanium, in which at least a part of the titanium is dissolved into a composite oxide of the cerium and the zirconium, and a ratio (I₁₁₁/I₂₂₂) of an intensity (I₁₁₁) of a superlattice peak of a diffraction line derived from a plane (111) to an intensity (I₂₂₂) of a main peak of a diffraction line derived from a plane (222) obtained from an X-ray diffraction pattern using CuKα obtained through an X-ray diffraction measurement satisfies the following condition. Condition (1): 2≤{(I₁₁₁/I₂₂₂)×100}≤15 (1)

JP 2019-189484 A discloses an oxygen storage material that contains a Ce—Zr-Ln-Ti-based composite oxide containing cerium (Ce), zirconium (Zr), a rare-earth element (Ln: however, cerium is excluded), and titanium (Ti), in which at least a part of the rare-earth element and at least a part of the titanium are dissolved into a composite oxide of the cerium and the zirconium, and the Ce—Zr-Ln-Ti-based composite oxide has a composition represented by the following chemical formula. Chemical formula (1): Ceₐ₋ₓLnₓZr_{b-y}Ti_{y}O₆ (1) (in the chemical formula (1), a, b, x, and y are numbers satisfying conditions of a=0.4 to 0.6, b=0.4 to 0.6, x=0 to a (however, x=0 or x=a is excluded), y=0 to 0.3 (however, y=0 is excluded), and a+b=1, and δ is a number from 1.7 to 2.2.

### SUMMARY

However, in the ceria-zirconia composite oxide in which the pyrochlore phase-type ordered array phase is formed as disclosed in JP 2009-84061 A, JP 2018-131365 A, and JP 2019-189484 A, the use of zirconium (Zr), which is a rare metal, may increase the cost. Further, in the composite oxide, an activation energy for releasing excess oxygen from the crystalline structure is high, and there is a problem of a high temperature required for oxygen release.

Therefore, one aspect of the present disclosure provides an inexpensive oxygen storage material having an excellent oxygen release performance at low temperature.

The present inventors examined various kinds of means to solve the above-described problems, and as a result, found that a novel composite oxide having a crystalline structure of Ce₂TiO₆ type containing Ce and titanium (Ti) is excellent in oxygen storage property and oxygen release property at low temperature compared with Ce₂Zr₂O₇ having a pyrochlore-type crystalline structure containing Ce and Zr effective as an existing oxygen storage material, thus completing one aspect of the present disclosure. Furthermore, the present inventors found that a novel composite oxide having a crystalline structure of Ce₂TiO₆ type containing aluminum (Al) in addition to Ce and titanium (Ti) is excellent in oxygen storage property and oxygen release property at low temperature compared with Ce₂Zr₂O₇ having a pyrochlore-type crystalline structure containing Ce and Zr effective as an existing oxygen storage material, and the novel composite oxide has a further larger oxygen storage amount than that of Ce₂TiO₆, thus completing one aspect of the present disclosure.

That is, the gist of the one aspect of the present disclosure is as follows.
(1) A composite oxide having a composition represented by a general formula Ce₂₋ₓAₓBO_{6-y}. In the formula, A is one or more elements selected from rare-earth metal elements excluding Ce, B is one or more elements selected from the group consisting of titanium (Ti) and Group 14 elements, 2−x, x, and 6−y are mole ratios of Ce, A, and O, respectively when B is assumed to be 1, and x and y satisfy 0≤x<2, 0≤y≤0.5x, respectively.
(2) In the composite oxide according to (1), in an X-ray diffraction pattern in which a range of 2θ measured using CuKα as an X-ray source is 5 deg. to 90 deg., an angle of a maximum X-ray diffraction peak exhibiting a highest intensity is within the 2θ range of 27 deg. to 31 deg., and when a peak intensity of the maximum X-ray diffraction peak is represented by Iₐ, and a maximum peak intensity among the X-ray diffraction peaks within the 2θ range of 32 deg. to 36 deg. is represented by I_{b}, I_{b}/Iₐ satisfies 0.15≤I_{b}/Iₐ≤0.85.
(3) In the composite oxide according to (1) or (2), in a crystalline structure obtained from an X-ray diffraction after heating at 500° C. for 6 hours in the air, when a space group is Pnma and a Z-value is 4, lattice constants a, b, and c, and a lattice volume V satisfy 10.1 Å≤a≤11.1 Å, 3.68 Å≤b≤3.97 Å, 10.7 Å≤c≤11.6 Å, and 419 Å³≤V≤480 Å³, respectively (where numerical values are mutually exchangeable between the lattice constants a, b, and c).
(4) In the composite oxide according to any one of (1) to (3), A is one or more elements selected from the group consisting of yttrium (Y), lanthanum (La), praseodymium (Pr), and samarium (Sm).
(5) In the composite oxide according to any one of (1) to (4), x satisfies 0≤x≤1.5.
(6) In the composite oxide according to any one of (1) to (5), B is one or more elements selected from the group consisting of titanium (Ti) and silicon (Si).
(7) In the composite oxide according to any one of (1) to (6), y satisfies 0≤y≤0.2.
(8) An oxygen storage material containing the composite oxide according to any one of (1) to (7).
(9) In the oxygen storage material according to (8), the composite oxide supports a catalyst metal.
(10) In the oxygen storage material according to (9), the catalyst metal is one or more elements selected from the group consisting of rhodium (Rh), palladium (Pd), and platinum (Pt).
(11) An exhaust gas purification catalyst containing the composite oxide according to any one of (1) to (7) or the oxygen storage material according to any one of (8) to (10).
(12) A redox catalyst containing the composite oxide according to any one of (1) to (7) or the oxygen storage material according to any one of (8) to (10).
(13) An oxygen storage method using the composite oxide according to any one of (1) to (7) or the oxygen storage material according to any one of (8) to (10).
(14) An oxygen enrichment method using the composite oxide according to any one of (1) to (7) or the oxygen storage material according to any one of (8) to (10).
(15) An oxygen removal method using the composite oxide according to any one of (1) to (7) or the oxygen storage material according to any one of (8) to (10).
(16) A heating and cooling method using the composite oxide according to any one of (1) to (7) or the oxygen storage material according to any one of (8) to (10).
(17) A method for producing the composite oxide according to any one of (1) to (7) that includes preparing a precursor containing the metal elements of the composite oxide, and heating the precursor in a reducing atmosphere.
(18) A composite oxide having a composition represented by a general formula Ce_{2-w-x′}A_{w}A′_{x′}B_{1-y′-z}B′_{y′}B″_{z}O_{6-w/2-x′-y′/2-z}. In in the formula, A is one or more elements selected from rare-earth metal elements excluding Ce, A′ is one or more elements selected from alkaline earth metal elements, B is one or more elements selected from the group consisting of titanium (Ti) and Group 14 elements, B′ is one or more elements selected from the group consisting of Group 13 elements, B″ is one or more elements selected from the group consisting of Group 12 elements, 2−w−x′, w, x′, 1−y′−z, y′, z, and 6−w/2−x′−y′/2−z are mole ratios of Ce, A, A′, B, B′, B″, and O, respectively when B+B′+B″ is assumed to be 1, w, x′, y′, and z satisfy 0≤w<2, 0≤x′<0.5, 0≤y′≤1, 0≤z≤0.5, respectively, and w+x′ satisfies 0≤w+x′<2, and y′+z satisfies 0≤y′+z≤1.
(19) In the composite oxide according to (18), in an X-ray diffraction pattern in which a range of 2θ measured using CuKα as an X-ray source is 5 deg. to 90 deg., an angle of a maximum X-ray diffraction peak exhibiting a highest intensity is within the 2θ range of 27 deg. to 31 deg., and when a peak intensity of the maximum X-ray diffraction peak is represented by Iₐ, and a maximum peak intensity among the X-ray diffraction peaks within the 20 range of 32 deg. to 37 deg. is represented by I_{b}, I_{b}/Iₐ satisfies 0.15≤I_{b}/Iₐ≤0.85.
(20) In the composite oxide according to (18) or (19), in a crystalline structure obtained from an X-ray diffraction after heating at 500° C. for 6 hours in the air, when a space group is Pnma and a Z-value is 4, lattice constants a, b, and c, and a lattice volume V satisfy 10.1 Å≤a≤11.1 Å, 3.64 Å≤b≤3.97 Å, 10.5 Å≤c≤11.7 Å, and 412 Å³≤V≤480 Å³, respectively (where numerical values are mutually exchangeable between the lattice constants a, b, and c).
(21) In the composite oxide according to any one of (18) to (20), A is one or more elements selected from the group consisting of yttrium (Y), lanthanum (La), praseodymium (Pr), samarium (Sm), europium (Eu), and ytterbium (Yb).
(22) In the composite oxide according to any one of (18) to (21), w satisfies 0≤w≤1.5.
(23) In the composite oxide according to any one of (18) to (22), A is one or more elements selected from the group consisting of calcium (Ca) and strontium (Sr).
(24) In the composite oxide according to any one of (18) to (23), x′ satisfies 0≤x′≤0.1.
(25) In the composite oxide according to (18) to (24), B is one or more elements selected from the group consisting of titanium (Ti) and silicon (Si).
(26) In the composite oxide according to (18) to (25), B′ is one or more elements selected from the group consisting of aluminum (Al) and gallium (Ga).
(27) In the composite oxide according to (18) to (26), B″ is zinc (Zn).
(28) In the composite oxide according to (18) to (27), z satisfies 0≤z≤0.2.
(29) In the composite oxide according to (18) to (28), B includes titanium (Ti) and 1−y′−z satisfies 0≤1−y′−z, or B′ includes aluminum (Al) and y′ satisfies 0<y′.
(30) An oxygen storage material containing the composite oxide according to (18) to (29).
(31) The oxygen storage material according to (30) that supports a catalyst metal.
(32) In the oxygen storage material according to (30) or (31), the catalyst metal is one or more elements selected from the group consisting of rhodium (Rh), palladium (Pd), and platinum (Pt).
(33) An exhaust gas purification catalyst containing the composite oxide according to any one of (18) to (29) or the oxygen storage material according to any one of (30) to (32).
(34) A redox catalyst containing the composite oxide according to any one of (18) to (29) or the oxygen storage material according to any one of (30) to (32).
(35) An oxygen storage method using the composite oxide according to any one of (18) to (29) or the oxygen storage material according to any one of (30) to (32).
(36) An oxygen enrichment method using the composite oxide according to any one of (18) to (29) or the oxygen storage material according to any one of (30) to (32).
(37) An oxygen removal method using the composite oxide according to any one of (18) to (29) or the oxygen storage material according to any one of (30) to (32).
(38) A heating and cooling method using the composite oxide according to any one of (18) to (29) or the oxygen storage material according to any one of (30) to (32).
(39) A method for producing the composite oxide according to any one of (18) to (29) that includes preparing a precursor containing the metal elements of the composite oxide, and heating the precursor in a reducing atmosphere.
(40) In the method according to (39), w+x′+y′+z satisfies 0<w+x′+y′+z.

The one aspect of the present disclosure provides the inexpensive oxygen storage material with the excellent oxygen release performance at low temperature.

### BRIEF DESCRIPTION OF THE DRAWINGS

FIG. 1A to FIG. 1C are diagrams schematically illustrating a crystalline structure of La₂TiO₅ (A), a crystalline structure of Ce₂TiO₆ as a novel composite oxide (B), and a crystalline structure of Ce₂TiO₆-type Ce₂Ti_{0.8}Al_{0.2}O_{5.9} as a further novel composite oxide (C);

FIG. 2A to FIG. 2D illustrate X-ray diffraction patterns of products of Examples 1 to 5 and Comparative Examples 1 to 8;

FIG. 3A to FIG. 3C illustrate X-ray diffraction patterns of products of Examples 1 to 3 and 6 to 11, and Comparative Example 9;

FIG. 4A illustrates H₂TPR results of the products of Examples 1 and 13 and Comparative Example 3 before and after supporting Pd, and FIG. 4B is a graph illustrating oxygen storage amounts of the products of Examples 1 and 13 and Comparative Example 3 after supporting Pd;

FIG. 5A and FIG. 5B are graphs illustrating weight changes of the products of Examples 1 to 11 and Comparative Examples 4 to 8;

FIG. 6 illustrates X-ray diffraction patterns of the product of Example 1 before and after reduction;

FIG. 7A to FIG. 7D illustrate X-ray diffraction patterns of the products of Examples 1 and 12 to 21 and Comparative Examples 11 and 12;

FIG. 8A to FIG. 8D illustrate X-ray diffraction patterns of the products of Examples 1 and 22 to 31 and Comparative Examples 10 and 13; and

FIG. 9 is a graph illustrating oxygen storage amounts at respective temperatures of Examples 1, 3, 4, 13, 19, 20, 26, and 27 and Comparative Example 3 in which Pd is supported.

### DETAILED DESCRIPTION

The following describes some embodiments of one aspect of the present disclosure in detail.

In the description, features of the one aspect of the present disclosure is described with reference to the drawings as necessary. In the drawings, dimensions and shapes of respective components are exaggerated for clarification, and actual dimensions and shapes are not accurately illustrated. Accordingly, the technical scope of the one aspect of the present disclosure is not limited to the dimensions or the shapes of respective components illustrated in the drawings. A novel composite oxide and an oxygen storage material containing the same of the one aspect of the present disclosure are not limited to the embodiments below, and can be performed in various configurations where changes, improvements, and the like which a person skilled in the art can make are given without departing from the gist of the one aspect of the present disclosure.

The one aspect of the present disclosure relates to a composite oxide having a composition represented by a general formula Ce₂₋ₓAₓBO_{6-y}, and an oxygen storage material containing the composite oxide.

The composite oxide having the composition represented by the general formula Ce₂₋ₓAₓBO_{6-y} (hereinafter also referred to as a “novel composite oxide”) is obtained in an oxidized state, and Ce, A, B, and O, and x and y are as follows.

Ce is cerium. Cerium is usually tetravalent cerium(IV). O is oxygen.

A is a rare-earth metal element excluding Ce. In one embodiment, A is one or more elements selected from the group consisting of yttrium (Y), lanthanum (La), praseodymium (Pr), samarium (Sm), europium (Eu), terbium (Tb), ytterbium (Yb), and lutetium (Lu). In one embodiment, A is one or more elements selected from the group consisting of Y, La, Pr, and Sm. The valence of A is not limited. The valence of A is usually divalent, trivalent, tetravalent, or a mixture thereof.

B is one or more elements selected from the group consisting of titanium (Ti) and Group 14 elements. In one embodiment, B is one or more elements selected from the group consisting of Ti, silicon (Si), germanium (Ge), tin (Sn), and lead (Pb). In one embodiment, B is one or more elements selected from the group consisting of Ti and Si. In one embodiment, B includes Ti. When B is two or more elements, a ratio thereof is not limited. In one embodiment, B is Ti and Si, and a mole ratio thereof is usually 95:5 to 75:25, and in one embodiment, 90:10 to 80:20. In one embodiment, B is Ti. The valence of B is not limited. The valence of B is usually tetravalent.

2−x, x, and 6−y are mole ratios of Ce, A, and O, respectively when B is assumed to be 1. Here, x satisfies 0≤x<2, satisfies 0≤x≤1.5 in one embodiment, and satisfies 0≤x≤1.0 in one embodiment. 6−y is a number that can change so as to have the valence of the entire complex compound of 0 based on the amount and the valence of Ce, A, and B, and y satisfies 0≤y≤0.5x, and satisfies 0≤y≤0.2 in one embodiment.

With the amount of Ce and the type and the amount of A and B as described above, a sufficient oxygen storage capacity can be ensured.

In one aspect of the present disclosure, the novel composite oxide is Ce₂TiO₆, Ce₂Ti_{0.9}Si_{0.1}O₆, Ce₂Ti_{0.8}Si_{0.2}O₆, Ce_{1.5}Y_{0.5}TiO_{5.75}, CeYTiO_{5.5}, Ce_{0.5}Y_{1.5}TiO_{5.25}, Ce_{1.5}La_{0.5}TiO_{5.75}, CeLaTiO_{5.5}, Ce_{0.5}La_{1.5}TiO_{5.25}, Ce_{1.5}Pr_{0.5}TiO_{5.75}, or Ce_{1.5}Sm_{0.5}TiO_{5.75}.

Furthermore, one aspect of the present disclosure relates to a composite oxide having a composition represented by a general formula Ce_{2-w-x′}A_{w}A′_{x′}B_{1-y′-z}B′_{y′}B″_{z}O_{6-w/2-x′-y′/2-z}, and an oxygen storage material containing the composite oxide.

The composite oxide having the composition represented by the general formula Ce_{2-w-x′}A_{w}A′_{x′}B_{1-y′-z}B′_{y′}B″_{z}O_{6-w/2-x′-y′/2-z} (hereinafter also referred to as a “further novel composite oxide,” the further novel composite oxide includes the novel composite oxide) is obtained in an oxidized state, Ce, A, B, and O is defined similarly to those described in the novel composite oxide, and A′, B′, and B″, and x′, y′, z, and w are as follows.

A′ is an alkaline earth metal element. In one embodiment, A′ is one or more elements selected from the group consisting of beryllium (Be), magnesium (Mg), calcium (Ca), strontium (Sr), barium (Ba), and radium (Ra). In one embodiment, A′ is one or more elements selected from the group consisting of Ca and Sr. In one embodiment, A′ includes Ca or Sr. When A′ is two or more elements, a ratio thereof is not limited. In one embodiment, A′ is Ca and Sr, and a mole ratio thereof is usually 95:5 to 5:95, and in one embodiment, 90:10 to 10:90. In one embodiment, A′ is Ca or Sr. In one embodiment, A′ is Ca. In one embodiment, A′ is Sr. The valence of A′ is usually divalent.

B′ is one or more elements selected from the group consisting of Group 13 elements. In one embodiment, B′ is one or more elements selected from the group consisting of boron (B), aluminum (Al), gallium (Ga), indium (In), and thallium (Tl). In one embodiment, B′ is one or more elements selected from the group consisting of Al and Ga. In one embodiment, B′ includes Al or Ga. When B′ is two or more elements, a ratio thereof is not limited. In one embodiment, B′ is Al and Ga, and a mole ratio thereof is usually 95:5 to 5:95, and in one embodiment, 90:10 to 10:90. In one embodiment, B′ is Al or Ga. In one embodiment, B′ is Al. In one embodiment, B′ is Ga. The valence of B′ is usually trivalent.

B″ is one or more elements selected from the group consisting of Group 12 elements. In one embodiment, B″ is one or more elements selected from the group consisting of zinc (Zn), cadmium (Cd), and mercury (Hg). In one embodiment, B″ is one or more elements selected from the group consisting of Zn and Cd. In one embodiment, B″ includes Zn. When B″ is two or more elements, a ratio thereof is not limited. In one embodiment, B″ is Zn and Cd, and a mole ratio thereof is usually 95:5 to 75:25, and in one embodiment, 90:10 to 80:20. In one embodiment, B″ is Zn. The valence of B″ is usually divalent.

2−w−x′, w, x′, 1−y′−z, y′, z, and 6−w/2−x′−y′/2−z are mole ratios of Ce, A, A′, B, B′, B″, and O, respectively when B+B′+B″ is assumed to be 1. Here, w satisfies 0≤w<2. x′ satisfies 0≤x′<0.5. y′ satisfies 0≤y′≤1. z satisfies 0≤z≤0.5. w+x′ satisfies 0≤w+x′<2. y′+z satisfies 0≤y′+z≤1. w+x′+y′+z satisfies 0≤w+x′+y′+z, and in one embodiment, satisfies 0<w+x′+y′+z. 1−y′−z satisfies 0≤1−y′−z in one embodiment, and satisfies 0<1−y′−z in one embodiment. 6−w/2−x′−y′/2−z is a number that can change so as to have the valence of the entire complex compound of 0 based on the amount and the valence of Ce, A, A′, B, B′, and B″.

With the amount of Ce and the type and the amount of A, A′, B, B′, and B″ as described above, the sufficient oxygen storage capacity can be ensured.

In one aspect of the present disclosure, the further novel composite oxide is Ce₂Ti_{0.9}Al_{0.1}O_{5.95}, Ce₂Ti_{0.8}Al_{0.2}O_{5.9}, Ce₂Ti_{0.9}Zn_{0.1}O_{5.9}, Ce₂Ti_{0.8}Zn_{0.2}O_{5.8}, Ce₂Ti_{0.9}Ga_{0.1}O_{5.95}, Ce₂Ti_{0.8}Ga_{0.2}O_{5.9}, Ce₂Ti_{0.5}Ga_{0.5}O_{5.75}, Ce_{1.5}Y_{0.5}Ti_{0.5}Al_{0.5}O_{5.5}, Ce_{1.5}Yb_{0.5}Ti_{0.5}Al_{0.5}O_{5.5}, CeYAlO₅, Ce_{1.5}Y_{0.5}TiO_{5.75}, Ce_{1.5}La_{0.5}TiO_{5.75}, Ce_{1.5}Pr_{0.5}TiO_{5.75}, Ce_{1.5}Sm_{0.5}TiO_{5.75}, Ce_{1.5}Eu_{0.5}TiO_{5.75}, Ce_{1.5}Yb_{0.5}TiO_{5.75}, Ce₂Ti_{0.9}Al_{0.1}O_{5.95}, Ce₂Ti_{0.9}Ga_{0.1}O_{5.95}, Ce_{1.9}Ca_{0.1}TiO_{5.9}, or Ce_{1.9}Sr_{0.1}TiO_{5.9}.

In one aspect of the present disclosure, by replacing a part or the whole of Ti⁴⁺ in Ce₂TiO₆ with lower-valence cations, such as Al³⁺, O²⁻ vacancies can be introduced, thereby providing the following effects.
(1) The O²⁻ conductivity is improved, and the oxygen storage amount at low temperature is increased.
(2) Since the formula weight becomes smaller relative to the Ce content, the oxygen storage amount per unit mass increases.
(3) The reducibility and O²⁻ conductivity are improved, and the Ce₂TiO₆-type structure is formed even at a low firing temperature (1,000° C.).

In one aspect of the present disclosure, the crystalline structures of the novel composite oxide and the further novel composite oxide can be determined by an X-ray diffraction (XRD) analysis.

For the novel composite oxide, in an X-ray diffraction pattern in which a range of 2θ measured using CuKα as an X-ray source is 5 deg. (°) to 90 deg., an angle of a maximum X-ray diffraction peak exhibiting the highest intensity is within the 2θ range of 27 deg. to 31 deg. Furthermore, in the X-ray diffraction pattern of the novel composite oxide, when a peak intensity of the maximum X-ray diffraction peak is represented by Iₐ, and a maximum peak intensity among the X-ray diffraction peaks within the 2θ range of 32 deg. to 36 deg. is represented by I_{b}, I_{b}/Iₐ satisfies 0.15≤I_{b}/Iₐ≤0.85.

For the novel composite oxide and the further novel composite oxide, in an X-ray diffraction pattern in which a range of 2θ measured using CuKα as an X-ray source is 5 deg. (°) to 90 deg., an angle of a maximum X-ray diffraction peak exhibiting the highest intensity is within the 2θ range of 27 deg. to 31 deg. Furthermore, in the X-ray diffraction pattern of the novel composite oxide and the further novel composite oxide, when a peak intensity of the maximum X-ray diffraction peak is represented by Iₐ, and a maximum peak intensity among the X-ray diffraction peaks within the 20 range of 32 deg. to 37 deg. is represented by I_{b}, I_{b}/Iₐ satisfies 0.15≤I_{b}/Iₐ≤0.85.

In the X-ray diffraction pattern of the novel composite oxide measured using CuKα as an X-ray source, for example, when the novel composite oxide is Ce₂TiO₆, the peak appears at at least one position, at least two positions in one embodiment, at least three positions in one embodiment, at least four positions in one embodiment, at least five positions in one embodiment, at least six positions in one embodiment, and all of seven positions in one embodiment of positions at which 2θ is 23.3°±0.5°, 24.9°±0.5°, 29.1°±0.5°, 29.6°±0.5°, 30.5°±0.5°, 33.5°±0.5°, and 35.0°±0.5°. The above-described peak positions (2θ) are distinctive in Ce₂TiO₆ as one aspect of the present disclosure, and one or more peaks may further appear at positions (2θ) other than the above-described positions.

In the X-ray diffraction pattern of the novel composite oxide measured using CuKα as an X-ray source, for example, when the novel composite oxide is Ce_{1.5}Y_{0.5}TiO_{5.75}, the peak appears at at least one position, at least two positions in one embodiment, at least three positions in one embodiment, at least four positions in one embodiment, at least five positions in one embodiment, and all of six positions in one embodiment of positions at which 2θ is 23.3°±0.5°, 25.1°±0.5°, 29.4°±0.5°, 30.4°±0.5°, 33.6°±0.5°, and 34.8°±0.5°. The above-described peak positions (2θ) are distinctive in Ce_{1.5}Y_{0.5}TiO_{5.75} as one aspect of the present disclosure, and one or more peaks may further appear at positions (2θ) other than the above-described positions.

Furthermore, in a crystalline structure obtained from the X-ray diffraction after heating the novel composite oxide at 500° C. for 6 hours in the air, when a space group is Pnma and a Z-value is 4, the lattice constants a, b, and c, and a lattice volume V are 10.1 Å≤a≤11.1 Å, 3.68 Å≤b≤3.97 Å, 10.7 Å≤c≤11.6 Å, and 419 Å³≤V≤480 Å³, respectively (where numerical values are mutually exchangeable between the lattice constants a, b, and c).

In a crystalline structure obtained from the X-ray diffraction after heating the novel composite oxide and the further novel composite oxide at 500° C. for 6 hours in the air, when a space group is Pnma and a Z-value is 4, the lattice constants a, b, and c, and a lattice volume V are 10.1 Å≤a≤11.1 Å, 3.64 Å≤b≤3.97 Å, 10.5 Å≤c≤11.7 Å, and 412 Å³≤V≤480 Å³, respectively (where numerical values are mutually exchangeable between the lattice constants a, b, and c).

The novel composite oxide in one aspect of the present disclosure has a novel crystalline structure with the XRD pattern as described above, and is also referred to as a Ce₂TiO₆-type crystalline structure in this specification and the like. Furthermore, the further novel composite oxide in one aspect of the present disclosure also has the Ce₂TiO₆-type crystalline structure.

The XRD spectrum of the Ce₂TiO₆-type crystalline structure has the peak position that can be changed based on the composition of the novel composite oxide and the further novel composite oxide. This matter is a known matter in this technical field.

The novel composite oxide and the further novel composite oxide in one aspect of the present disclosure exhibit the oxidized state as described above, but exhibit oxygen storage property by repeating the change between the oxidized state and the reduced state in the use aspect. The reduced state of the novel composite oxide in one aspect of the present disclosure is represented by, for example, a general formula Ce₂₋ₓAₓBO_{6-y-δ}. Here, while Ce, A, B, and O, and x and y are as described above, Ce includes trivalent Ce, and δ usually satisfies 0≤δ≤1 although may be changed depending on the degree of reduction. Furthermore, the reduced state of the further novel composite oxide in one aspect of the present disclosure is represented by, for example, a general formula Ce_{2-w-x′}A_{w}A′_{x′}B_{1-y′-z}B′_{y′}B″_{z}O_{6-w/2-x′-y′/2-z-δ}. Here, while Ce, A, A′, B, B′, B″, and O, and w, x′, y′ and z are as described above, Ce includes trivalent Ce, and δ usually satisfies 0≤δ≤1 although may be changed depending on the degree of reduction.

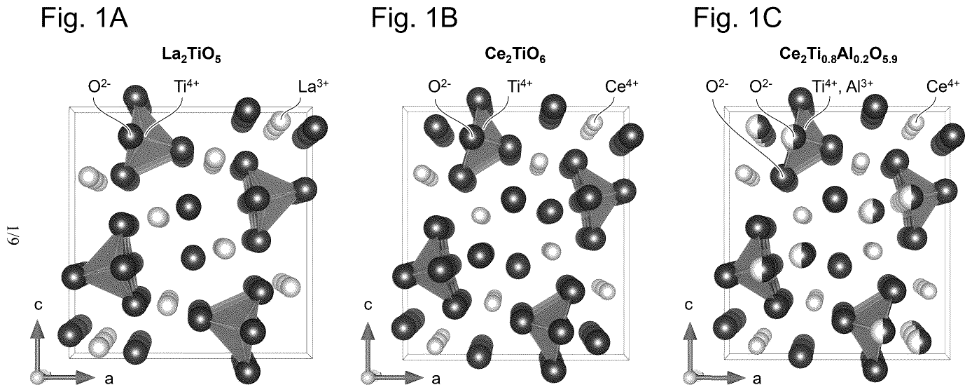

FIG. 1A to FIG. 1C schematically illustrate La₂TiO₅(FIG. 1A) having a Y₂TiO₅-type crystalline structure, the crystalline structure of Ce₂TiO₆ (FIG. 1B) that is the novel composite oxide in one aspect of the present disclosure, and the crystalline structure of Ce₂TiO₆-type Ce₂Ti_{0.8}Al_{0.2}O_{5.9} (FIG. 1C) that is the further novel composite oxide in one aspect of the present disclosure. From FIG. 1B, the novel composite oxide contains tetravalent cerium ions (Ce⁴⁺) and tetravalent titanium ions (Ti⁴⁺) in the oxidized state, and has a novel crystalline structure (Ce₂TiO₆-type) in which the Y₂TiO₅-type (La₂TiO₅) incorporates oxide ions (O²⁻). It is considered that in the novel composite oxide, Ce⁴⁺ changes to Ce³⁺ and desorption of O²⁻ simultaneously occurs in a reducing atmosphere, and the crystalline structure becomes close to the Y₂TiO₅-type, thereby releasing oxygen. From FIG. 1C, when the tetravalent titanium ions (Ti⁴⁺) in Ce₂TiO₆ are replaced with aluminum ions (Al³⁺), vacancies are introduced into the oxide ion (O²⁻) sites for charge compensation, resulting in Ce₂Ti_{0.8}Al_{0.2}O_{5.9}, and the O²⁻ conductivity is improved and the oxygen storage amount at low temperature (300° C.) increases. Furthermore, due to the replacement of Ti in Ce₂TiO₆ with Al that is a light element and the introduction of O²⁻ vacancies, the formula weight of Ce₂Ti_{0.8}Al_{0.2}O_{5.9} is reduced, and the maximum oxygen storage amount (oxygen storage amount per unit mass) at high temperature (>400° C.) increases. By replacing Ce⁴⁺ with Y³⁺ or La³⁺, or replacing Ti⁴⁺ with Al³⁺ or Ga³⁺ in Ce₂TiO₆, vacancies are introduced into the O²⁻ sites for charge compensation, thereby improving the O²⁻ conductivity and forming the Ce₂TiO₆-type structure even at a low firing temperature (1,000° C.).

Accordingly, one aspect of the present disclosure relates to an oxygen storage material containing the novel composite oxide and/or the further novel composite oxide of one aspect of the present disclosure.

The oxygen storage material of one aspect of the present disclosure may further contain a catalyst metal. The catalyst metal may be supported on the novel composite oxide and/or the further novel composite oxide described above. Examples of the catalyst metal include a noble metal. Although not limited, examples of the noble metal include platinum group noble metals. Examples of the platinum group noble metals include ruthenium (Ru), rhodium (Rh), palladium (Pd), osmium (Os), iridium (Ir), and platinum (Pt). In one embodiment, the noble metal is one or more metals selected from the group consisting of Rh, Pt, and Pd. A support amount of the noble metal is similar to that in a conventional exhaust gas purification catalyst, and not limited, but usually 0.01 weight % to 5 weight %, and 0.5 weight % to 2 weight % in one embodiment with respect to a total weight of the oxygen storage material.

The oxygen storage material of one aspect of the present disclosure is excellent in oxygen release at low temperature. Accordingly, one aspect of the present disclosure relates also to an exhaust gas purification catalyst and/or a redox catalyst containing the oxygen storage material of one aspect of the present disclosure.

The exhaust gas purification catalyst and/or the redox catalyst of one aspect of the present disclosure may contain a carrier material other than the oxygen storage material of one aspect of the present disclosure. Examples of the carrier material other than the oxygen storage material of one aspect of the present disclosure include a porous and highly heat resistant metal oxide, and for example, aluminum oxide (alumina: Al₂O₃), zirconium oxide (zirconia: ZrO₂), and silicon oxide (silica: SiO₂), or composite oxides containing these metal oxides as a main component can be used. In the exhaust gas purification catalyst, as the supporting method, a conventional supporting method, such as an adsorption supporting method and a water-absorption supporting method, can be used.

The exhaust gas purification catalyst and/or redox catalyst of one aspect of the present disclosure can exhibit an excellent ordered structure durability and OSC performance over a wide temperature range. The exhaust gas purification catalyst of one aspect of the present disclosure is usually used in a low temperature range of about 200° C. to 600° C.

Further, by utilizing the property of absorbing and releasing oxygen and the property of having different energy states in the state of adsorbing oxygen and the state of releasing oxygen of the oxygen storage material of one aspect of the present disclosure, the use of the oxygen storage material of one aspect of the present disclosure allows storing oxygen (oxygen storage method), enriching oxygen (oxygen enrichment method), removing oxygen (oxygen removal method), and/or heating and/or cooling it (heating/cooling method).

In one aspect of the present disclosure, the novel composite oxide and the further novel composite oxide can be produced by an ordinary method in this technical field, such as a solid phase method, a liquid phase method, or an alkoxide method, excluding that the firing is performed under a reducing atmosphere.

In the case of the method for producing the novel composite oxide of one aspect of the present disclosure, the novel composite oxide is produced, for example, by mixing an aqueous solution of a cerium compound, a titanium compound and/or a compound containing a Group 14 element, and optionally a compound containing an element other than Ce or Ti as described above (hereinafter, also referred to as a “cerium compound and the like”) and an aqueous solution of a complexing agent, and drying the mixture to deposit a product containing Ce, Ti, and the like, and then firing the product in a reducing atmosphere. The cerium compound and the like can also be used as a solution of a non-aqueous solvent, such as alcohol or organic carboxylic acid ester.

As the cerium compound, for example, water-soluble compounds including nitrates such as cerium nitrate and diammonium cerium nitrate, sulfates such as ceric sulfate, and chlorides such as cerium chloride, and compounds soluble in alcohol or an organic solvent including alkoxides such as cerium isopropoxide can be used.

As the silicon compound, alkoxides such as tetraethyl orthosilicate, tetraisopropyl orthosilicate, and the like can be used.

As the titanium compound, for example, alkoxides such as titanium(IV) tetraisopropoxide, titanium(IV) dihydroxy-bis (ammonium lactato), titanium(IV) oxysulfate, titanium(IV) sulfate, and the like can be used.

As the compound containing elements other than Ce or Ti, water-soluble or alcohol-soluble compounds such as nitrate, sulfate, chloride, or alkoxide can be used.

Examples of the complexing agent include, but are not particularly limited to, polycarboxylic acids, polyhydric alcohols, amino acids, and the like. Examples of the polycarboxylic acid include oxalic acid, malonic acid, succinic acid, glutaric acid, adipic acid, maleic acid, citric acid, tartaric acid, malic acid, and the like. In one embodiment, the complexing agent is citric acid. Examples of the polyhydric alcohol include ethylene glycol, glycerin, propylene glycol, butylene glycol, and the like. In one embodiment, the complexing agent is ethylene glycol. Examples of the amino acid include glycine, alanine, asparagine, aspartic acid, and the like.

When a precipitate is formed by mixing the aqueous solution of the cerium compound and the like with the aqueous solution of the complexing agent, drying may be performed after filtering the precipitate.

The drying of the mixed solution of the aqueous solution of the cerium compound and the like and the aqueous solution of the complexing agent can be performed usually at 50° C. to 1500° C., usually for 5 hours to 48 hours. Furthermore, the product containing Ce, Ti, and the like obtained by the drying may be calcined in the air usually at 400° C. to 600° C., for example, 500° C., usually for 4 hours to 8 hours, for example, 6 hours.

The firing of the product containing Ce, Ti, and the like can be performed by heating and holding the product usually at 600° C. to 1500° C. usually for 2 hours to 48 hours in a reducing atmosphere. The reducing atmosphere can be an inert gas atmosphere, a non-oxidizing atmosphere, or an atmosphere containing a reductant, and can be an atmosphere containing a reducing gas such as H₂, CO, and the like, an atmosphere containing carbon, for example, activated carbon, or, for example, a closed atmosphere in one embodiment. Thus, the novel composite oxide having the Ce₂TiO₆-type crystalline structure is obtained.

The method for producing the further novel composite oxide of one aspect of the present disclosure is similar to the method for producing the novel composite oxide of one aspect of the present disclosure excluding that the compound containing the elements contained in the further novel composite oxide is further used. In the method for producing the further novel composite oxide, the compound containing A′, B′, or B″ is not limited, and a water-soluble compound or a compound soluble in alcohol or an organic solvent, for example, nitrate, sulfate, chloride, or alkoxide, can be used.

### EXAMPLES

While the following describes some Examples regarding the one aspect of the present disclosure, it is not intended to limit the one aspect of the present disclosure to those described in such Examples.

### 1. Production of Oxygen Storage Material Containing Novel Composite Oxide

### 1-1. Reagent

Cerium(III) nitrate hexahydrate (Ce(NO₃)₃·6H₂O) (manufactured by Nacalai Tesque, INC.) ≥35.0 weight % (as CeO₂)
Yttrium(III) nitrate hexahydrate (Y(NO₃)₃·6H₂O) (manufactured by Kanto Chemical Co., Inc.) >99.99 weight %
Lanthanum(III) nitrate hexahydrate (La(NO₃)₃·6H₂O) (manufactured by Nacalai Tesque, INC.)≥99.9 weight %
Praseodymium(III) nitrate hexahydrate (Pr(NO₃)₃·6H₂O) (manufactured by Kanto Chemical Co., Inc.)>99.95 weight %
Samarium(III) nitrate hexahydrate (Sm(NO₃)₃·6H₂O) (manufactured by FUJIFILM Wako Pure Chemical Corporation) 99.5 weight %
Europium(III) nitrate hexahydrate (Eu(NO₃)₂·6H₂O) (manufactured by Kanto Chemical Co., Inc.) >99.95 weight %
Ytterbium(III) nitrate pentahydrate (Yb(NO₃)₃·5H₂O) (manufactured by Sigma-Aldrich) 99.9 weight %
Titanium(IV) tetraisopropoxide (Ti(iPrO)₄) (manufactured by Kanto Chemical Co., Inc.) >97.0 weight %
Titanium(IV) dihydroxy-bis (ammonium lactato) ((NH₄)₂Ti(OH)₂(Lac)₂) (manufactured by Tokyo Chemical Industry Co., Ltd.) about 40 weight % of isopropyl alcohol solution
Aluminum nitrate nonahydrate (Al(NO₃)₃·9H₂O) (manufactured by FUJIFILM Wako Pure Chemical Corporation) 98.0+ weight %
Tetraethyl orthosilicate (Si(EtO)₄) (manufactured by Tokyo Chemical Industry Co., Ltd.) >98.0 weight %
Zinc nitrate hexahydrate (Zn(NO₃)₂·6H₂O) (manufactured by FUJIFILM Wako Pure Chemical Corporation) 99.0+ weight %
Gallium nitrate octahydrate (Ga(NO₃)₃·8H₂O) (manufactured by TAIYO CAMPANYCO., LTD) 99 weight %
Calcium nitrate tetrahydrate (Ca(NO₃)₂·4H₂O) (manufactured by FUJIFILM Wako Pure Chemical Corporation) 98.5+ weight %
Strontium nitrate (Sr(NO₃)₂) (manufactured by FUJIFILM Wako Pure Chemical Corporation) 98.0 to 102.0 weight %
Zirconium nitrate oxide dihydrate (ZrO(NO₃)₂·2H₂O) (manufactured by Kanto Chemical Co., Inc.) >99.0 weight %
Citric acid (manufactured by FUJIFILM Wako Pure Chemical Corporation) 98.0+ weight %
Ethylene glycol (manufactured by Nacalai Tesque, INC.) 99.5 weight %
28% ammonia solution (manufactured by FUJIFILM Wako Pure Chemical Corporation) 25.0 weight % to 30.0 weight %
Palladium(II) nitrate (Pd(NO₃)₂) (manufactured by FUJIFILM Wako Pure Chemical Corporation) 97.0+ weight %

### 1-2. Production of Composite Oxide

### Example 1

(1) A stirrer was put in a 1,000 mL glass beaker, and Ce(NO₃)₃·6H₂O (7.24 g, 16.7 mmol) and Ti(iPrO)₄ (2.37 g, 8.33 mmol) as raw materials, citric acid (19.2 g, 100 mmol) and ethylene glycol (6.21 g, 100 mmol) as additives, and ethanol (100 mL) as a solvent were added.
(2) The solution was heated while being stirred using a hot stirrer, and evaporated to dryness.
(3) The contents were collected, the stirrer was removed, and the contents were pulverized and mixed in a mortar.
(4) The powder was transferred to an alumina crucible, calcined in the air at 500° C. for 6 hours using a muffle furnace, and a precursor was collected.
(5) The precursor (0.3 g) was mixed with an activated carbon pellet (0.3 g) and added to the alumina crucible, the alumina crucible was put in an alumina square container, a large excess of activated carbon pellet was put over the alumina crucible, and the alumina square container was covered with an alumina plate and fired in the air at 1150° C. for 16 hours.
(6) The mixture of the powder and the activated carbon pellet was sieved to remove the large activated carbon pellet, and a product was collected.

### Comparative Example 1

A product was collected similarly to Example 1 except that the raw material was changed to Ce(NO₃)₃·6H₂O (10.9 g, 25.0 mmol).

### Comparative Example 2

A product was collected similarly to Example 1 except that the raw material was changed to Ce(NO₃)₃·6H₂O (5.43 g, 12.5 mmol) and Ti(iPrO)₄ (3.55 g, 12.5 mmol).

### Comparative Example 3

(1) A stirrer was put in a 1,000 mL glass beaker, and Ce(NO₃)₃·6H₂O (8.68 g, 20.0 mmol) and ZrO(NO₃)₂·6H₂O (5.35 g, 20.0 mmol) as raw materials and distilled water (100 mL) as a solvent were added and stirred to be dissolved.
(2) 28% ammonia solution (32 mL) was diluted with distilled water (900 mL), the solution of (1) was added thereto, and the stirring was continued at room temperature for one whole day and night.
(3) The obtained solution and precipitate were transferred to a centrifuge tube and centrifuged at 3,000 rpm for 5 minutes to remove a supernatant.
(4) Distilled water (500 mL) was added to the obtained precipitate to redisperse the precipitate, and the precipitate was centrifuged. This operation was repeated twice to wash the precipitate.
(5) The obtained precipitate was calcined in the air at 250° C. for 2 hours, and pulverized in a mortar.
(6) The obtained powder was fired in the air at 800° C. for 5 hours, and the obtained powder was subjected to compression molding at 2 t.
(7) The molded body was fired at 1400° C. for 5 hours under a 10% H₂/N₂ flow at 5 L·min⁻¹, and a product was collected.

### Comparative Example 4

(1) A stirrer was put in a 1,000 mL glass beaker, and Ce(NO₃)₃·6H₂O (10.9 g, 25.0 mmol) as a raw material, citric acid (19.2 g, 100 mmol) and ethylene glycol (6.21 g, 100 mmol) as additives, and ethanol (100 mL) as a solvent were added.
(2) The solution was heated while being stirred using a hot stirrer, and evaporated to dryness.
(3) The contents were collected, the stirrer was removed, and the contents were pulverized and mixed in a mortar.
(4) The powder was transferred to an alumina crucible, calcined in the air at 500° C. for 6 hours using a muffle furnace, and a precursor was collected.
(5) The precursor (0.3 g) was added to the alumina crucible and fired in the air at 1150° C. for 16 hours, and a product was collected.

### Comparative Example 5

A product was collected similarly to Comparative Example 4 except that the raw material was changed to Ce(NO₃)₃·6H₂O (7.24 g, 16.7 mmol) and Ti(iPrO)₄ (2.37 g, 8.33 mmol).

### Comparative Example 6

A product was collected similarly to Comparative Example 4 except that the raw material was changed to Ce(NO₃)₃·6H₂O (5.43 g, 12.5 mmol) and Ti(iPrO)₄ (3.55 g, 12.5 mmol).

### Comparative Example 7

A product was collected similarly to Example 1 except that the raw material was changed to La(NO₃)₃·6H₂O (7.22 g, 16.7 mmol) and Ti(iPrO)₄ (2.37 g, 8.33 mmol).

### Comparative Example 8

A product was collected similarly to Example 1 except that the raw material was changed to Pr(NO₃)₃·6H₂O (7.25 g, 16.7 mmol) and Ti(iPrO)₄ (2.37 g, 8.33 mmol).

### Example 2

A product was collected similarly to Example 1 except that the raw material was changed to Ce(NO₃)₃·6H₂O (5.43 g, 12.5 mmol), Y(NO₃)₃·6H₂O (1.60 g, 4.17 mmol), and Ti(iPrO)₄ (2.37 g, 8.33 mmol).

### Example 3

A product was collected similarly to Example 1 except that the raw material was changed to Ce(NO₃)₃·6H₂O (5.43 g, 12.5 mmol), La(NO₃)₃·6H₂O (1.80 g, 4.17 mmol), and Ti(iPrO)₄ (2.37 g, 8.33 mmol).

### Example 4

A product was collected similarly to Example 1 except that the raw material was changed to Ce(NO₃)₃·6H₂O (5.43 g, 12.5 mmol), Pr(NO₃)₃·6H₂O (1.81 g, 4.17 mmol), and Ti(iPrO)₄ (2.37 g, 8.33 mmol).

### Example 5

A product was collected similarly to Example 1 except that the raw material was changed to Ce(NO₃)₃·6H₂O (5.43 g, 12.5 mmol), Sm(NO₃)₃·6H₂O (1.81 g, 4.17 mmol), and Ti(iPrO)₄ (2.37 g, 8.33 mmol).

### Example 6

A product was collected similarly to Example 1 except that the raw material was changed to Ce(NO₃)₃·6H₂O (7.24 g, 16.7 mmol), Ti(iPrO)₄ (2.13 g, 7.50 mmol), and Si(EtO)₄ (0.174 g, 0.833 mmol).

### Example 7

A product was collected similarly to Example 1 except that the raw material was changed to Ce(NO₃)₃·6H₂O (7.24 g, 16.7 mmol), Ti(iPrO)₄ (1.89 g, 6.67 mmol), and Si(EtO)₄ (0.347 g, 1.67 mmol).

### Comparative Example 9

A product was collected similarly to Example 1 except that the raw material was changed to Ce(NO₃)₃·6H₂O (7.24 g, 16.7 mmol), Ti(iPrO)₄ (1.18 g, 4.17 mmol), and Si(EtO)₄ (0.868 g, 4.17 mmol).

### Example 8

A product was collected similarly to Example 1 except that the raw material was changed to Ce(NO₃)₃·6H₂O (3.62 g, 8.33 mmol), Y(NO₃)₃·6H₂O (3.19 g, 8.33 mmol), and Ti(iPrO)₄ (2.37 g, 8.33 mmol).

### Example 9

A product was collected similarly to Example 1 except that the raw material was changed to Ce(NO₃)₃·6H₂O (3.62 g, 8.33 mmol), La(NO₃)₃·6H₂O (3.61 g, 8.33 mmol), and Ti(iPrO)₄ (2.37 g, 8.33 mmol).

### Example 10

A product was collected similarly to Example 1 except that the raw material was changed to Ce(NO₃)₃·6H₂O (1.81 g, 4.17 mmol), Y(NO₃)₃·6H₂O (4.79 g, 12.5 mmol), and Ti(iPrO)₄ (2.37 g, 8.33 mmol).

### Example 11

A product was collected similarly to Example 1 except that the raw material was changed to Ce(NO₃)₃·6H₂O (1.81 g, 4.17 mmol), La(NO₃)₃·6H₂O (5.41 g, 12.5 mmol), and Ti(iPrO)₄ (2.37 g, 8.33 mmol).

### Example 12

A product was collected similarly to Example 1 except that the raw material was changed to Ce(NO₃)₃·6H₂O (7.24 g, 16.7 mmol), Ti(iPrO)₄ (2.13 g, 7.50 mmol), and Al(NO₃)₃·9H₂O (0.313 g, 0.833 mmol).

### Example 13

A product was collected similarly to Example 1 except that the raw material was changed to Ce(NO₃)₃·6H₂O (7.24 g, 16.7 mmol), Ti(iPrO)₄ (1.89 g, 6.67 mmol), and Al(NO₃)₃·9H₂O (0.625 g, 1.67 mmol).

### Comparative Example 11

A product was collected similarly to Example 1 except that the raw material was changed to Ce(NO₃)₃·6H₂O (7.24 g, 16.7 mmol), Ti(iPrO)₄ (1.18 g, 4.17 mmol), and Al(NO₃)₃·9H₂O (1.56 g, 4.17 mmol).

### Example 14

A product was collected similarly to Example 1 except that the raw material was changed to Ce(NO₃)₃·6H₂O (7.24 g, 16.7 mmol), (NH₄)₂Ti(OH)₂(Lac)₂ (4.43 g, 7.50 mmol), and Zn(NO₃)₂·6H₂O (0.297 g, 1.00 mmol), and the firing temperature was changed to 1,075° C. Since a Zn oxide exhibits volatility under a reducing atmosphere at high temperatures, the raw material composition contains 20 mol % excess Zn.

### Example 15

A product was collected similarly to Example 1 except that the raw material was changed to Ce(NO₃)₃·6H₂O (7.24 g, 16.7 mmol), (NH₄)₂Ti(OH)₂(Lac)₂ (3.94 g, 6.67 mmol), and Zn(NO₃)₂·6H₂O (0.595 g, 2.00 mmol), and the firing temperature was changed to 1,075° C. Since a Zn oxide exhibits volatility under a reducing atmosphere at high temperatures, the raw material composition contains 20 mol % excess Zn.

### Comparative Example 12

A product was collected similarly to Example 1 except that the raw material was changed to Ce(NO₃)₃·6H₂O (7.24 g, 16.7 mmol), (NH₄)₂Ti(OH)₂(Lac)₂ (2.46 g, 4.17 mmol), and Zn(NO₃)₂·6H₂O (1.49 g, 5.00 mmol), and the firing temperature was changed to 1,075° C. Since a Zn oxide exhibits volatility under a reducing atmosphere at high temperatures, the raw material composition contains 20 mol % excess Zn.

### Example 16

A product was collected similarly to Example 1 except that the raw material was changed to Ce(NO₃)₃·6H₂O (7.24 g, 16.7 mmol), (NH₄)₂Ti(OH)₂(Lac)₂ (4.43 g, 7.50 mmol), and Ga(NO₃)₃·8H₂O (0.350 g, 0.875 mmol), and the firing temperature was changed to 1,000° C. Since a Ga oxide exhibits volatility under a reducing atmosphere at high temperatures, the raw material composition contains 5 mol % excess Ga.

### Example 17

A product was collected similarly to Example 1 except that the raw material was changed to Ce(NO₃)₃·6H₂O (7.24 g, 16.7 mmol), (NH₄)₂Ti(OH)₂(Lac)₂ (3.94 g, 6.67 mmol), and Ga(NO₃)₃·8H₂O (0.700 g, 1.75 mmol), and the firing temperature was changed to 1,000° C. Since a Ga oxide exhibits volatility under a reducing atmosphere at high temperatures, the raw material composition contains 5 mol % excess Ga.

### Example 18

A product was collected similarly to Example 1 except that the raw material was changed to Ce(NO₃)₃·6H₂O (7.24 g, 16.7 mmol), (NH₄)₂Ti(OH)₂(Lac)₂ (2.46 g, 4.17 mmol), and Ga(NO₃)₃·8H₂O (1.75 g, 4.38 mmol), and the firing temperature was changed to 1,075° C. Since a Ga oxide exhibits volatility under a reducing atmosphere at high temperatures, the raw material composition contains 5 mol % excess Ga.

### Example 19

A product was collected similarly to Example 1 except that the raw material was changed to Ce(NO₃)₃·6H₂O (5.42 g, 12.5 mmol), Y(NO₃)₃·6H₂O (1.60 g, 4.17 mmol), (NH₄)₂Ti(OH)₂(Lac)₂ (2.46 g, 4.17 mmol), and Al(NO₃)₃·9H₂O (1.56 g, 4.17 mmol).

### Example 20

A product was collected similarly to Example 1 except that the raw material was changed to Ce(NO₃)₃·6H₂O (5.42 g, 12.5 mmol), Yb(NO₃)₃·5H₂O (1.87 g, 4.17 mmol), (NH₄)₂Ti(OH)₂(Lac)₂ (2.46 g, 4.17 mmol), and Al(NO₃)₃·9H₂O (1.56 g, 4.17 mmol).

### Example 21

A product was collected similarly to Example 1 except that the raw material was changed to Ce(NO₃)₃·6H₂O (3.62 g, 8.33 mmol), Y(NO₃)₃·6H₂O (3.19 g, 8.33 mmol), and Al(NO₃)₃·9H₂O (3.13 g, 8.33 mmol).

### Comparative Example 13

A product was collected similarly to Example 1 except that the firing temperature was changed to 1,000° C.

### Example 22

A product was collected similarly to Example 1 except that the raw material was changed to Ce(NO₃)₃·6H₂O (5.43 g, 12.5 mmol), Y(NO₃)₃·6H₂O (1.60 g, 4.17 mmol), and Ti(iPrO)₄ (2.37 g, 8.33 mmol), and the firing temperature was changed to 1,000° C.

### Example 23

A product was collected similarly to Example 1 except that the raw material was changed to Ce(NO₃)₃·6H₂O (5.43 g, 12.5 mmol), La(NO₃)₃·6H₂O (1.80 g, 4.17 mmol), and Ti(iPrO)₄ (2.37 g, 8.33 mmol), and the firing temperature was changed to 1,000° C.

### Example 24

A product was collected similarly to Example 1 except that the raw material was changed to Ce(NO₃)₃·6H₂O (5.43 g, 12.5 mmol), Pr(NO₃)₃·6H₂O (1.81 g, 4.17 mmol), and Ti(iPrO)₄ (2.37 g, 8.33 mmol), and the firing temperature was changed to 1,000° C.

### Example 25

A product was collected similarly to Example 1 except that the raw material was changed to Ce(NO₃)₃·6H₂O (5.43 g, 12.5 mmol), Sm(NO₃)₃·6H₂O (1.81 g, 4.17 mmol), and Ti(iPrO)₄ (2.37 g, 8.33 mmol), and the firing temperature was changed to 1,000° C.

### Example 26

A product was collected similarly to Example 1 except that the raw material was changed to Ce(NO₃)₃·6H₂O (5.43 g, 12.5 mmol), Eu(NO₃)₃·6H₂O (1.86 g, 4.17 mmol), and Ti(iPrO)₄ (2.37 g, 8.33 mmol), and the firing temperature was changed to 1,000° C.

### Example 27

A product was collected similarly to Example 1 except that the raw material was changed to Ce(NO₃)₃·6H₂O (5.43 g, 12.5 mmol), Yb(NO₃)₃·5H₂O (1.87 g, 4.17 mmol), and Ti(iPrO)₄ (2.37 g, 8.33 mmol), and the firing temperature was changed to 1,000° C.

### Example 28

A product was collected similarly to Example 1 except that the raw material was changed to Ce(NO₃)₃·6H₂O (7.24 g, 16.7 mmol), Ti(iPrO)₄ (2.13 g, 7.50 mmol), and Al(NO₃)₃·9H₂O (0.313 g, 0.833 mmol), and the firing temperature was changed to 1,000° C.

### Example 29

A product was collected similarly to Example 1 except that the raw material was changed to Ce(NO₃)₃·6H₂O (7.24 g, 16.7 mmol), (NH₄)₂Ti(OH)₂(Lac)₂ (4.43 g, 7.50 mmol), and Ga(NO₃)₃·8H₂O (0.350 g, 0.875 mmol), and the firing temperature was changed to 1,000° C. Since a Ga oxide exhibits volatility under a reducing atmosphere at high temperatures, the raw material composition contains 5 mol % excess Ga.

### Example 30

A product was collected similarly to Example 1 except that the raw material was changed to Ce(NO₃)₃·6H₂O (6.88 g, 15.8 mmol), Ca(NO₃)₂·4H₂O (0.197 g, 0.833 mmol), and (NH₄)₂Ti(OH)₂(Lac)₂ (4.92 g, 8.33 mmol).

### Example 31

A product was collected similarly to Example 1 except that the raw material was changed to Ce(NO₃)₃·6H₂O (6.88 g, 15.8 mmol), Sr(NO₃)₂ (0.176 g, 0.833 mmol), and (NH₄)₂Ti(OH)₂(Lac)₂ (4.92 g, 8.33 mmol).

### Comparative Example 10

A product was collected similarly to Example 1 except that the raw material was changed to Ce(NO₃)₃·6H₂O (5.43 g, 12.5 mmol), Sr(NO₃)₂ (0.882 g, 4.17 mmol mmol), and (NH₄)₂Ti(OH)₂(Lac)₂ (4.92 g, 8.33 mmol).

### 2. Analysis and Evaluation of Product

### 2-1. X-ray Diffraction Measurement (Confirmation of Crystalline Structure of Product)

An X-ray diffraction (XRD) measurement was performed on each of the products of Examples 1 to 31 and Comparative Examples 1 to 13. The measurement device and the measurement condition are described below.
Measurement device: RINT RAPID II (manufactured by Rigaku Corporation)
Measurement condition: Voltage 50 V, current 100 mA, collimator diameter φ 0.3 mm, sample angle ω 15°

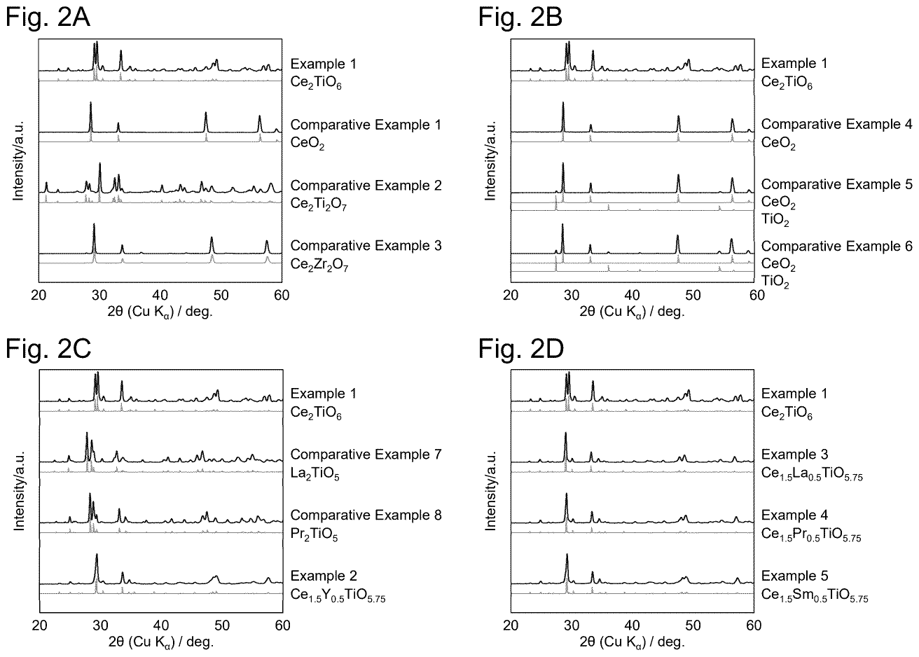

FIG. 2A illustrates X-ray diffraction patterns of the products of Example 1 and Comparative Examples 1 to 3. For Ce₂TiO₆, fluorite-type CeO₂, layered perovskite-type Ce₂Ti₂O₇, and pyrochlore-type Ce₂Zr₂O₇, X-ray diffraction patterns expected from the crystalline structures were calculated, and compared with the X-ray diffraction patterns of the respective products.

FIG. 2B illustrates X-ray diffraction patterns of the products of Example 1 and Comparative Examples 4 to 6. For Ce₂TiO₆, fluorite-type CeO₂, and rutile-type TiO₂, X-ray diffraction patterns expected from the crystalline structures were calculated, and compared with the X-ray diffraction patterns of the respective products.

The following was found from FIG. 2A and FIG. 2B.

The product of Example 1 was Ce₂TiO₆ of the Ce₂TiO₆-type. The precursor was calcined in the air at 500° C., and is considered to be an oxide containing Ce⁴⁺ and Ti⁴⁺. By firing the precursor containing Ce⁴⁺ and Ti⁴⁺ in the reducing atmosphere, at least a part of Ce is converted to Ce³⁺, and Ce₂TiO₅ in which La³⁺ of La₂TiO₅ has been replaced with Ce³⁺ is formed. During the cooling process after the firing, when the activated carbon ceases to combust, the atmosphere is no longer reducing, Ce₂TiO₅ reacts with O₂ in the air at a temperature at which Ce³⁺ and Ti⁴⁺ are immobile, and Ce³⁺ is oxidized to Ce⁴⁺, thereby forming Ce₂TiO₆.

The product of Comparative Example 1 was fluorite-type CeO₂, and the product of Comparative Example 2 was layered perovskite-type Ce₂Ti₂O₇. From this result, it was found that by firing the precursor having the ratio of Ce+A:B=2:1 as the above-described general formula, the crystalline structure of Ce₂TiO₆-type is formed.

The product of comparative example 3 was pyrochlore-type Ce₂Zr₂O₇. The molded body was fired in the air at 800° C., and is considered to be an oxide containing Ce⁴⁺ and Zr⁴⁺. By firing the precursor containing Ce⁴⁺ and Zr⁴⁺ in the reducing atmosphere, at least a part of Ce is converted to Ce³⁺. Due to increased differences in electric charge and ionic radius between Ce³⁺ and Zr⁴⁺, Ce³⁺ and Zr⁴⁺ arranged in an ordered manner become more stable, thereby forming the pyrochlore-type Ce₂Zr₂O₇.

The product of Comparative Example 4 was fluorite-type CeO₂, and the products of Comparative Example 5 and Comparative Example 6 were mixtures of fluorite-type CeO₂ and rutile-type TiO₂. When the precursor containing Ce⁴⁺ and Ti⁴⁺ is fired in the air, Ce⁴⁺ is not reduced, and Ce⁴⁺ and Ti⁴⁺ become stabilized in the state of CeO₂ and TiO₂, respectively, resulting in the mixture of CeO₂ and TiO₂.

From these results, it was found that performing firing in the reducing atmosphere once is necessary to form Ce₂TiO₆.

FIG. 2C illustrates X-ray diffraction patterns of the products of Examples 1 and 2 and Comparative Examples 7 and 8. For Ce₂TiO₆, La₂TiO₅, Pr₂TiO₅, and Ce₂TiO₆-type Ce_{1.5}Y_{0.5}TiO_{5.75}, X-ray diffraction patterns expected from the crystalline structures were calculated, and compared with the X-ray diffraction patterns of the respective products.

FIG. 2D illustrates X-ray diffraction patterns of the products of Examples 1 and 3 to 5. For Ce₂TiO₆, Ce₂TiO₆-type Ce_{1.5}La_{0.5}TiO_{5.75}, Ce₂TiO₆-type Ce_{1.5}Pr_{0.5}TiO_{5.75}, Ce₂TiO₆-type Ce_{1.5}Sm_{0.5}TiO_{5.75}, X-ray diffraction patterns expected from the crystalline structures were calculated, and compared with the X-ray diffraction patterns of the respective products.

The following was found from FIG. 2C and FIG. 2D.

The product of Comparative Example 7 was Y₂TiO₅-type La₂TiO₅. The precursor was calcined in the air at 500° C., and is considered to be an oxide containing La³⁺ and Ti⁴⁺. By firing the precursor containing La³⁺ and Ti⁴⁺, La₂TiO₅ is formed.

The product of Comparative Example 8 was Pr₂TiO₅. The precursor was calcined in the air at 500° C., and is considered to be an oxide containing Pr³⁺ or Pr⁴⁺, and Ti⁴⁺. By firing the precursor containing Pr³⁺ or Pr⁴⁺, and Ti⁴⁺ in the reducing atmosphere, at least a part of Pr is converted to Pr³⁺, and Pr₂TiO₅ in which La³⁺ of La₂TiO₅ has been replaced with Pr³⁺ is formed.

The product of Example 2 was Ce₂TiO₆-type Ce_{1.5}Y_{0.5}TiO_{5.75}, the product of Example 3 was Ce₂TiO₆-type Ce_{1.5}La_{0.5}TiO_{5.75}, the product of Example 4 was Ce₂TiO₆-type Ce_{1.5}Pr_{0.5}TiO_{5.75}, and the product of Example 5 was Ce₂TiO₆-type Ce_{1.5}Sm_{0.5}TiO_{5.75}. Ce of Ce₂TiO₆ can be replaced with a rare-earth metal element other than Ce. When Ce⁴⁺ is replaced with a trivalent rare-earth metal ion, the oxygen amount decreases for charge compensation.

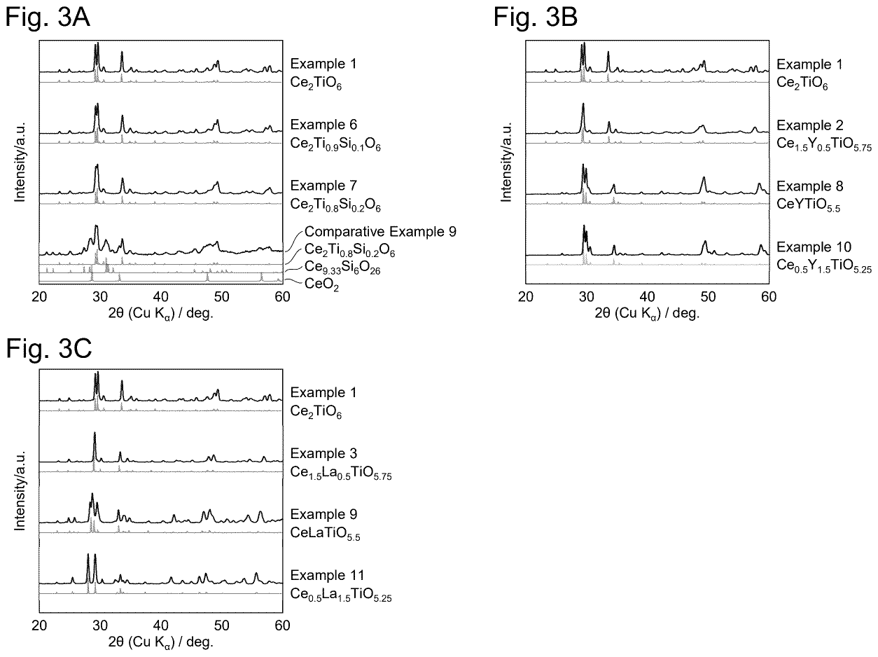

FIG. 3A illustrates X-ray diffraction patterns of the products of Examples 1, 6, and 7 and Comparative Example 9. For Ce₂TiO₆, Ce₂TiO₆-type Ce₂Ti_{0.9}Si_{0.1}O₆, Ce₂TiO₆-type Ce₂Ti_{0.8}Si_{0.2}O₆, apatite-type Ce_{9.33}Si₆O₂₆, and fluorite-type CeO₂, X-ray diffraction patterns expected from the crystalline structures were calculated, and compared with the X-ray diffraction patterns of the respective products.

The following was found from FIG. 3A.

The product of Example 6 was Ce₂TiO₆-type Ce₂Ti_{0.9}Si_{0.1}O₆, the product of Example 7 was Ce₂TiO₆-type Ce₂Ti_{0.8}Si_{0.2}O₆, and the product of Comparative Example 9 was a mixture of Ce₂TiO₆-type Ce₂Ti_{0.8}Si_{0.2}O₆, apatite-type Ce_{9.33}Si₆O₂₆, and fluorite-type CeO₂. Ti of Ce₂TiO₆ can be replaced with another element, such as Si. When the amount of replacement with Si increases, the mixture of Ce₂TiO₆-type Ce₂Ti_{0.8}Si_{0.2}O₆, apatite-type Ce_{9.33}Si₆O₂₆, and CeO₂ is obtained.

FIG. 3B illustrates X-ray diffraction patterns of the products of Examples 1, 2, 8, and 10. For Ce₂TiO₆, Ce₂TiO₆-type Ce_{1.5}Y_{0.5}TiO_{5.75}, Ce₂TiO₆-type CeYTiO_{5.5}, Ce₂TiO₆-type Ce_{0.5}Y_{1.5}TiO_{5.25}, X-ray diffraction patterns expected from the crystalline structures were calculated, and compared with the X-ray diffraction patterns of the respective products.

FIG. 3C illustrates X-ray diffraction patterns of the products of Examples 1, 3, 9, and 11. For Ce₂TiO₆, Ce₂TiO₆-type Ce_{1.5}La_{0.5}TiO_{5.75}, Ce₂TiO₆-type CeLaTiO_{5.5}, Ce₂TiO₆-type Ce_{0.5}La_{1.5}TiO_{5.25}, X-ray diffraction patterns expected from the crystalline structures were calculated, and compared with the X-ray diffraction patterns of the respective products.

The following was found from FIG. 3B and FIG. 3C.

The product of Example 8 was Ce₂TiO₆-type CeYTiO_{5.5}, the product of Example 9 was Ce₂TiO₆-type CeLaTiO_{5.5}, the product of Example 10 was Ce₂TiO₆-type Ce_{0.5}Y_{1.5}TiO_{5.25}, and the product of Example 11 was Ce₂TiO₆-type Ce_{0.5}La_{1.5}TiO_{5.25}. Ce of Ce₂TiO₆ can be replaced with an appropriate amount of rare-earth metal element other than Ce.

Table 1 illustrates the raw material, the firing condition, and the phase included in the obtained product for Examples 1 to 11 and Comparative Examples 1 to 9.

TABLE 1
Products of Examples 1 to 11 and Comparative Examples 1 to 9

| | Raw Material | Firing Condition | Product (Phase) |
|---|---|---|---|
| Example 1 | Ce:Ti = 2:1 | Activated Carbon | Ce₂TiO₆ |
| | | Mixture 1,150° C. | |
| Example 2 | Ce:Y:Ti = 1.5:0.5:1 | Activated Carbon | Ce_{1.5}Y_{0.5}TiO_{5.75} |
| | | Mixture 1,150° C. | |
| Example 3 | Ce:La:Ti = 1.5:0.5:1 | Activated Carbon | Ce_{1.5}La_{0.5}TiO_{5.75} |
| | | Mixture 1,150° C. | |
| Example 4 | Ce:Pr:Ti = 1.5:0.5:1 | Activated Carbon | Ce_{1.5}Pr_{0.5}TiO_{5.75} |
| | | Mixture 1,150° C. | |
| Example 5 | Ce:Sm:Ti = 1.5:0.5:1 | Activated Carbon | Ce_{1.5}Sm_{0.6}TiO_{5.75} |
| | | Mixture 1,150° C. | |
| Example 6 | Ce:Ti:Si = 2:0.9:0.1 | Activated Carbon | Ce₂Ti_{0.9}Si_{0.1}O₆ |
| | | Mixture 1,150° C. | |
| Example 7 | Ce:Ti:Si = 2:0.8:0.2 | Activated Carbon | Ce₂Ti_{0.8}Si_{0.2}O₆ |
| | | Mixture 1,150° C. | |
| Example 8 | Ce:Y:Ti = 1:1:1 | Activated Carbon | CeYTiO_{5.5} |
| | | Mixture 1,150° C. | |
| Example 9 | Ce:La:Ti = 1:1:1 | Activated Carbon | CeLaTiO_{5.5} |
| | | Mixture 1,150° C. | |
| Example 10 | Ce:Y:Ti = 0.5:1.5:1 | Activated Carbon | Ce_{0.5}Y_{1.5}TiO_{5.25} |
| | | Mixture 1,150° C. | |
| Example 11 | Ce:La:Ti = 0.5:1.5:1 | Activated Carbon | Ce_{0.5}La_{1.5}TiO_{5.25} |
| | | Mixture 1,150° C. | |
| Comparative | Ce = 1 | Activated Carbon | CeO₂ |
| Example 1 | | Mixture 1,150° C. | |
| Comparative | Ca:Ti = 1:1 | Activated Carbon | Ce₂Ti₂O₇ |
| Example 2 | | Mixture 1,150° C. | |
| Comparative | Ce:Zr = 1:1 | 10% H2 Flow 1,400° C. | Ce₂Zr₂O₇ |
| Example 3 | | | |
| Comparative | Ce = 1 | In The Air 1,150° C. | CeO₂ |
| Example 4 | | | |
| Comparative | Ce:Ti = 2:1 | In The Air 1,150° C. | CeO₂ + TiO₂ |
| Example 5 | | | |
| Comparative | Ce:Ti = 1:1 | In The Air 1,150° C. | CeO₂ + TiO₂ |
| Example 6 | | | |
| Comparative | La:Ti = 1:1 | Activated Carbon | La₂TiO₅ |
| Example 7 | | Mixture 1,150° C. | |
| Comparative | Pr:Ti = 1:1 | Activated Carbon | Pr₂TiO₅ |
| Example 8 | | Mixture 1,150° C. | |
| Comparative | Ce:Ti:Si = 2:0.5:0.5 | Activated Carbon | Ce₂Ti_{0.8}Si_{0.2}O₆ + |
| Example 9 | | Mixture 1,150° C. | Ce_{9.33}Si₆O₂₆ + CeO₂ |

The products of Examples 1 to 11 are assumed to have the Ce₂TiO₆-type structure, and the lattice constants a, b, and c, and a lattice volume V when a space group is Pnma and a Z-value is 4 were each obtained. Table 2 illustrates the result.

TABLE 2
Lattice Constants a, b, and c, and Lattice Volume
V Obtained from X-ray Diffraction Pattern

| | | | | | Lattice |
|---|---|---|---|---|---|
| | | | | | Volume/ |
| | | Lattice Constant/Å | | | Å³ |
| | | a | b | c | V |
| Example 1 | Ce₂TiO₆ | 10.26 | 3.743 | 11.48 | 440.7 |
| Example 2 | Ce_{1.5}Y_{0.5}TiO_{5.75} | 10.34 | 3.755 | 11.34 | 440.4 |
| Example 3 | Ce_{1.5}La_{0.5}TiO_{5.75} | 10.40 | 3.810 | 11.48 | 454.3 |
| Example 4 | Ce_{1.5}Pr_{0.5}TiO_{5.75} | 10.36 | 3.793 | 11.42 | 448.7 |
| Example 5 | Ce_{1.5}Sm_{0.5}TiO_{5.75} | 10.33 | 3.779 | 11.40 | 445.2 |
| Example 6 | Ce₂Ti_{0.9}Si_{0.1}O₈ | 10.29 | 3.742 | 11.42 | 439.9 |
| Example 7 | Ce₂Ti_{0.8}Si_{0.2}O₈ | 10.30 | 3.746 | 11.40 | 439.8 |
| Example 8 | CeYTiO_{5.5} | 10.49 | 3.724 | 10.91 | 426.5 |
| Example 9 | CeLaTiO_{5.5} | 10.69 | 3.879 | 11.40 | 472.9 |
| Example 10 | Ce_{0.5}Y_{1.5}TiO_{5.25} | 10.43 | 3.722 | 10.91 | 423.3 |
| Example 11 | Ce_{0.5}La_{1.5}TiO_{5.25} | 10.93 | 3.922 | 11.08 | 475.1 |

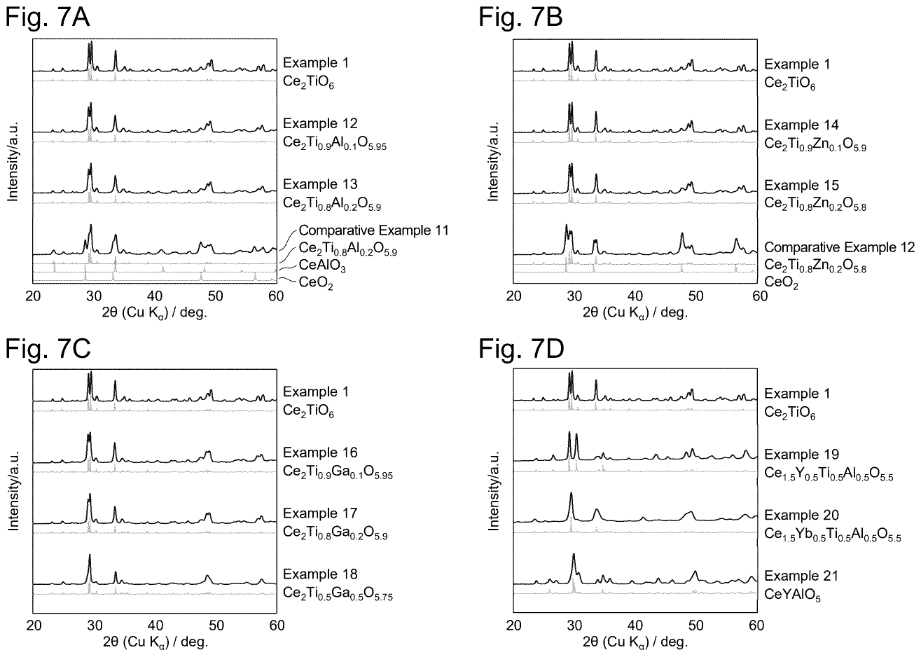

FIG. 7A illustrates X-ray diffraction patterns of the products of Examples 1, 12, 13 and Comparative Example 11. For Ce₂TiO₆, Ce₂TiO₆-type Ce₂Ti_{0.9}Al_{0.1}O_{5.95}, Ce₂TiO₆-type Ce₂Ti_{0.8}Al_{0.2}O_{5.9}, perovskite-type CeAlO₃, and fluorite-type CeO₂, X-ray diffraction patterns expected from the crystalline structures were calculated, and compared with the X-ray diffraction patterns of the respective products.

The following was found from FIG. 7A.

The product of Example 12 was Ce₂TiO₆-type Ce₂Ti_{0.9}Al_{0.1}O_{5.95}, the product of Example 13 was Ce₂TiO₆-type Ce₂Ti_{0.8}Al_{0.2}O_{5.9}, the product of Comparative Example 11 was a mixture of Ce₂TiO₆-type Ce₂Ti_{0.8}Al_{0.2}O_{5.9}, perovskite-type CeAlO₃, and fluorite-type CeO₂. Ti of Ce₂TiO₆ can be replaced with Al. Furthermore, when the amount of replacement with Al increases, the mixture of Ce₂TiO₆-type Ce₂Ti_{0.8}Al_{0.2}O_{5.9}, perovskite-type CeAlO₃, and fluorite-type CeO₂ is obtained.

FIG. 7B illustrates X-ray diffraction patterns of the products of Examples 1, 14, 15 and Comparative Example 12. For Ce₂TiO₆, Ce₂TiO₆-type Ce₂Ti_{0.9}Zn_{0.1}O_{5.9}, Ce₂TiO₆-type Ce₂Ti_{0.8}Zn_{0.2}O_{5.8}, and fluorite-type CeO₂, X-ray diffraction patterns expected from the crystalline structures were calculated, and compared with the X-ray diffraction patterns of the respective products.

The following was found from FIG. 7B.

The product of Example 14 was Ce₂TiO₆-type Ce₂Ti_{0.9}Zn_{0.1}O_{5.9}, the product of Example 15 was Ce₂TiO₆-type Ce₂Ti_{0.8}Zn_{0.2}O_{5.8}, the product of Comparative Example 12 was a mixture of Ce₂TiO₆-type Ce₂Ti_{0.8}Zn_{0.2}O_{5.8} and fluorite-type CeO₂. Ti of Ce₂TiO₆ can be replaced with Zn. Furthermore, when the amount of replacement with Zn increases, the mixture of Ce₂TiO₆-type Ce₂Ti_{0.8}Zn_{0.2}O_{5.8} and fluorite-type CeO₂ is obtained.

FIG. 7C illustrates X-ray diffraction patterns of the products of Examples 1 and 16 to 18. For Ce₂TiO₆, Ce₂TiO₆-type Ce₂Ti_{0.9}Ga_{0.1}O_{5.95}, Ce₂TiO₆-type Ce₂Ti_{0.8}Ga_{0.2}O_{5.9}, and Ce₂TiO₆-type Ce₂Ti_{0.5}Ga_{0.5}O_{5.75}, X-ray diffraction patterns expected from the crystalline structures were calculated, and compared with the X-ray diffraction patterns of the respective products.

The following was found from FIG. 7C.

The product of Example 16 was Ce₂TiO₆-type Ce₂Ti_{0.9}Ga_{0.1}O_{5.95}, the product of Example 17 was Ce₂TiO₆-type Ce₂Ti_{0.8}Ga_{0.2}O_{5.9}, and the product of Example 18 was Ce₂TiO₆-type Ce₂Ti_{0.5}Ga_{0.5}O_{5.75}. Ti of Ce₂TiO₆ can be replaced with Ga.

FIG. 7D illustrates X-ray diffraction patterns of the products of Examples 1 and 19 to 21. For Ce₂TiO₆, Ce₂TiO₆-type Ce_{1.5}Y_{0.5}Ti_{0.5}Al_{0.5}O_{5.5}, Ce₂TiO₆-type Ce_{1.5}Yb_{0.5}Ti_{0.5}Al_{0.5}O_{5.5}, and Ce₂TiO₆-type CeYAlO₅, X-ray diffraction patterns expected from the crystalline structures were calculated, and compared with the X-ray diffraction patterns of the respective products.

The following was found from FIG. 7D.

The product of Example 19 was Ce₂TiO₆-type Ce_{1.5}Y_{0.5}Ti_{0.5}Al_{0.5}O_{5.5}, the product of Example 20 was Ce₂TiO₆-type Ce_{1.5}Yb_{0.5}Ti_{0.5}Al_{0.5}O_{5.5}, and the product of Example 21 was Ce₂TiO₆-type CeYAlO₅. When Ti of Ce₂TiO₆ is replaced with Al, the replacement was allowed up to 20 mol %, but when Ce⁴⁺ is replaced with Y³⁺ or Yb³⁺ having the small ionic radius and valence, the amount of allowable replacement of Ti⁴⁺ with Al³⁺ to be increased (as for CeYAlO₅, Ti is not contained at all).

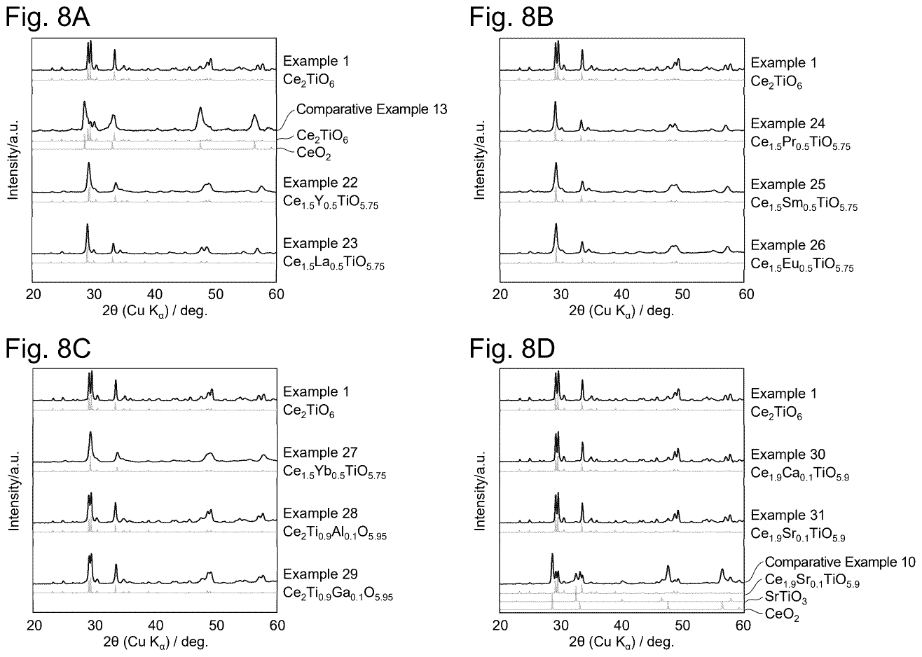

FIG. 8A illustrates X-ray diffraction patterns of the products of Examples 1, 22, 23 and Comparative Example 13. For Ce₂TiO₆, fluorite-type CeO₂, Ce₂TiO₆-type Ce_{1.5}Y_{0.5}TiO_{5.75}, and Ce₂TiO₆-type Ce_{1.5}La_{0.5}TiO_{5.75}, X-ray diffraction patterns expected from the crystalline structures were calculated, and compared with the X-ray diffraction patterns of the respective products.

Furthermore, FIG. 8B illustrates X-ray diffraction patterns of the products of Examples 1 and 24 to 26. For Ce₂TiO₆, Ce₂TiO₆-type Ce_{1.5}Pr_{0.5}TiO_{5.75}, Ce₂TiO₆-type Ce_{1.5}Sm_{0.5}TiO_{5.75}, and Ce₂TiO₆-type Ce_{1.5}Eu_{0.5}TiO_{5.75}, X-ray diffraction patterns expected from the crystalline structures were calculated, and compared with the X-ray diffraction patterns of the respective products.

Furthermore, FIG. 8C illustrates X-ray diffraction patterns of the products of Examples 1 and 27 to 29. For Ce₂TiO₆, Ce₂TiO₆-type Ce_{1.5}Yb_{0.5}TiO_{5.75}, Ce₂TiO₆-type Ce₂Ti_{0.9}Al_{0.1}O_{5.95}, and Ce₂TiO₆-type Ce₂Ti_{0.9}Ga_{0.1}O_{5.95}, X-ray diffraction patterns expected from the crystalline structures were calculated, and compared with the X-ray diffraction patterns of the respective products.

The following was found from FIG. 8A to FIG. 8C.

The product of Comparative Example 13 contains CeO₂ as a main component. While Ce₂TiO₆ is obtained by firing at 1,150° C. in the reducing atmosphere (Example 1), the reduction is insufficient at the firing temperature of 1,000° C. The product of Example 22 was Ce₂TiO₆-type Ce_{1.5}Y_{0.5}TiO_{5.75}, the product of Example 23 was Ce₂TiO₆-type Ce_{1.5}La_{0.5}TiO_{5.75}, the product of Example 24 was Ce₂TiO₆-type Ce_{1.5}Pr_{0.5}TiO_{5.75}, the product of Example 25 was Ce₂TiO₆-type Ce_{1.5}Sm_{0.5}TiO_{5.75}, the product of Example 26 was Ce₂TiO₆-type Ce_{1.5}Eu_{0.5}TiO_{5.75}, the product of Example 27 was Ce₂TiO₆-type Ce_{1.5}Yb_{0.5}TiO_{5.75}, the product of Example 28 was Ce₂TiO₆-type Ce₂Ti_{0.9}Al_{0.1}O_{5.95}, and the product of Example 29 was Ce₂TiO₆-type Ce₂Ti_{0.9}Ga_{0.1}O_{5.95}. By replacing Ce⁴⁺ of Ce₂TiO₆ with a rare-earth element ion, such as Y³⁺ or La³⁺, or replacing Ti⁴⁺ with Al³⁺ or Ga³⁺, vacancies are introduced into the O²⁻ sites for charge compensation, thereby improving the reducibility and the O²⁻ conductivity and forming the Ce₂TiO₆-type structure even at a low firing temperature.

FIG. 8D illustrates X-ray diffraction patterns of the products of Examples 1, 30, 31 and Comparative Example 10. For Ce₂TiO₆, Ce₂TiO₆-type Ce_{1.9}Ca_{0.1}TiO_{5.9}, Ce₂TiO₆-type Ce_{1.9}Sr_{0.1}TiO_{5.9}, perovskite-type SrTiO₃, and fluorite-type CeO₂, X-ray diffraction patterns expected from the crystalline structures were calculated, and compared with the X-ray diffraction patterns of the respective products.

The following was found from FIG. 8D.

The product of Example 30 was Ce₂TiO₆-type Ce_{1.9}Ca_{0.1}TiO_{5.9}, the product of Example 31 was Ce₂TiO₆-type Ce_{1.9}Sr_{0.1}TiO_{5.9}, and the product of Comparative Example 10 was a mixture of Ce₂TiO₆-type Ce_{1.9}Sr_{0.1}TiO_{5.9}, perovskite-type SrTiO₃, and fluorite-type CeO₂. Ce of Ce₂TiO₆ can be replaced with Ca or Sr. When the amount of replacement with Sr increases, the mixture of Ce₂TiO₆-type Ce_{1.9}Sr_{0.1}TiO_{5.9}, perovskite-type SrTiO₃, and fluorite-type CeO₂ is obtained.

Table 3 illustrates the raw material, the firing condition, and the phase included in the obtained product for Examples 12 to 31 and Comparative Examples 10 to 13.

TABLE 3
Products of Examples 12 to 31 and Comparative Examples 10 to 13

| | Raw Material | Firing Condition | Product (Phase) |
|---|---|---|---|
| Example 12 | Ce:Ti:Al = 2:0.9:0.1 | Activated Carbon | Ce₂Ti_{0.9}Al_{0.1}O_{5.95} |
| | | Mixture 1,150° C. | |
| Example 13 | Ce:Ti:Al = 2:0.8:0.2 | Activated Carbon | Ce₂Ti_{0.8}Al_{0.2}O_{5.9} |
| | | Mixture 1,150° C. | |
| Example 14 | Ce:Ti:Zn = 2:0.9:0.1 | Activated Carbon | Ce₂Ti_{0.9}Zn_{0.1}O_{5.9} |
| | | Mixture 1,075° C. | |
| Example 15 | Ce:Ti:Zn = 2:0.8:0.2 | Activated Carbon | Ce₂Ti_{0.8}Zn_{0.2}O_{5.8} |
| | | Mixture 1,075° C. | |
| Example 16 | Ce:Ti:Ga = 2:0.9:0.1 | Activated Carbon | Ce₂Ti_{0.9}Ga_{0.1}O_{5.95} |
| | | Mixture 1,000° C. | |
| Example 17 | Ce:Ti:Ga = 2:0.8:0.2 | Activated Carbon | Ce₂Ti_{0.8}Ga_{0.2}O_{5.9} |
| | | Mixture 1,000° C. | |
| Example 18 | Ce:Ti:Ga = 2:0.5:0.5 | Activated Carbon | Ce₂Ti_{0.5}Ga_{0.5}O_{5.75} |
| | | Mixture 1,075° C. | |
| Example 19 | Ce:Y:Ti:Al = 1.5:0.5:0.5:0.5 | Activated Carbon | Ce_{1.5}Y_{0.5}Ti_{0.5}Al_{0.5}O_{5.5} |
| | | Mixture 1,150° C. | |
| Example 20 | Ce:Yb:Ti:Al = 1.5:0.5:0.5:0.5 | Activated Carbon | Ce_{1.5}Yb_{0.5}Ti_{0.5}Al_{0.5}O_{5.5} |
| | | Mixture 1,150° C. | |
| Example 21 | Ce:Y:Al = 1:1:1 | Activated Carbon | CeYAlO₅ |
| | | Mixture 1,150° C. | |
| Example 22 | Ce:Y:Ti = 1.5:0.5:1 | Activated Carbon | Ce_{1.5}Y_{0.5}TiO_{5.75} |
| | | Mixture 1,000° C. | |
| Example 23 | Ce:La:Ti = 1.5:0.5:1 | Activated Carbon | Ce_{1.5}La_{0.5}TiO_{5.75} |
| | | Mixture 1,000° C. | |
| Example 24 | Ce:Pr:Ti = 1.5:0.5:1 | Activated Carbon | Ce_{1.5}Pr_{0.5}TiO_{5.75} |
| | | Mixture 1,000° C. | |
| Example 25 | Ce:Sm:Ti = 1.5:0.5:1 | Activated Carbon | Ce_{1.5}Sm_{0.5}TiO_{5.75} |
| | | Mixture 1,000° C. | |
| Example 26 | Ce:Eu:Ti = 1.5:0.5:1 | Activated Carbon | Ce_{1.5}Eu_{0.5}TiO_{5.75} |
| | | Mixture 1,000° C. | |
| Example 27 | Ce:Yb:Ti = 1.5:0.5:1 | Activated Carbon | Ce_{1.5}Yb_{0.5}TiO_{5.75} |
| | | Mixture 1,000° C. | |
| Example 28 | Ce:Ti:Al = 2:0.9:0.1 | Activated Carbon | Ce₂Ti_{0.9}Al_{0.1}O_{5.95} |
| | | Mixture 1,000° C. | |
| Example 29 | Ce:Ti:Ga = 2:0.9:0.1 | Activated Carbon | Ce₂Ti_{0.9}Ga_{0.1}O_{5.95} |
| | | Mixture 1,000° C. | |
| Example 30 | Ce:Ca:Ti = 1.9:0.1:1 | Activated Carbon | Ce_{1.9}Ca_{0.1}TiO_{5.9} |
| | | Mixture 1,150° C. | |
| Example 31 | Ce:Sr:Ti = 1.9:0.1:1 | Activated Carbon | Ce_{1.9}Sr_{0.1}TiO_{5.9} |
| | | Mixture 1,150° C. | |
| Comparative | Ce:Ti:Al = 2:0.5:0.5 | Activated Carbon | Ce₂Ti_{0.8}Al_{0.2}O_{5.9} + |
| Example 11 | | Mixture 1,150° C. | CeAlO₃ + CeO₂ |
| Comparative | Ce:Ti:Zn = 2:0.5:0.5 | Activated Carbon | Ce₂Ti_{0.8}Zn_{0.2}O_{5.8} + |
| Example 12 | | Mixture 1,075° C. | CeO₂ |
| Comparative | Ce:Ti = 2:1 | Activated Carbon | Ce₂TiO₆ + CeO₂ |
| Example 13 | | Mixture 1,000° C. | |
| Comparative | Ce:Sr:Ti = 1.5:0.5:1 | Activated Carbon | Ce₂TiO₆ + SrTiO₃ + |
| Example 10 | | Mixture 1,150° C. | CeO₂ |

The products of Examples 12 to 21, 26, 27, 30, and 31 are assumed to have the Ce₂TiO₆-type structure, and the lattice constants a, b, and c, and a lattice volume V when a space group is Pnma and a Z-value is 4 were each obtained. Table 4 illustrates the result.

TABLE 4
Lattice Constants a, b, and c, and Lattice Volume
V Obtained from X-ray Diffraction Pattern

| | | | | | Lattice |
|---|---|---|---|---|---|
| | | | | | Volume/ |
| | | Lattice Constant/Å | | | Å³ |
| | | a | b | c | V |
| Example 12 | Ce₂Ti_{0.9}Al_{0.1}O_{5.95} | 10.28 | 3.750 | 11.45 | 441.3 |
| Example 13 | Ce₂Ti_{0.5}Al_{0.2}O_{5.9} | 10.29 | 3.748 | 11.42 | 440.6 |
| Example 14 | Ce₂Ti_{0.9}Zn_{0.1}O_{5.9} | 10.27 | 3.746 | 11.49 | 442.1 |
| Example 15 | Ce₂Ti_{0.8}Zn_{0.2}O_{5.8} | 10.29 | 3.743 | 11.47 | 441.8 |
| Example 16 | Ce₂Ti_{0.9}Ga_{0.1}O_{5.95} | 10.31 | 3.752 | 11.44 | 442.6 |
| Example 17 | Ce₂Ti_{0.8}Ga_{0.2}O_{5.9} | 10.33 | 3.752 | 11.42 | 442.7 |
| Example 18 | Ce₂Ti_{0.5}Ga_{0.5}O_{5.75} | 10.37 | 3.748 | 11.34 | 440.8 |
| Example 19 | Ce_{1.5}Y_{0.5}Ti_{0.5}Al_{0.5}O_{5.5} | 10.56 | 3.770 | 10.67 | 425.0 |
| Example 20 | Ce_{1.5}Yb_{0.5}Ti_{0.5}Al_{0.55}O_{5.5} | 10.22 | 3.775 | 11.31 | 436.5 |
| Example 21 | CeYAlO₅ | 10.35 | 3.686 | 10.93 | 417.0 |
| Example 26 | Ce_{1.5}Eu_{0.5}TiO_{5.75} | 10.38 | 3.774 | 11.36 | 445.0 |
| Example 27 | Ce_{1.5}Yb_{0.5}TiO_{5.75} | 10.36 | 3.752 | 11.26 | 437.6 |
| Example 30 | Ce_{1.9}Ca_{0.1}TiO_{5.9} | 10.29 | 3.753 | 11.46 | 442.6 |
| Example 31 | Ce_{1.9}Sr_{0.1}TiO_{5.9} | 10.29 | 3.755 | 11.48 | 443.6 |

From Tables 1 to 4, the angles and the lattice constants at the X-ray diffraction peak of the composite oxides of the present disclosure are as follows.
Actually measured 2θ of Ia: 27.84 to 30.28, range of ±0.5
Actually measured 2θ of Ib: 32.76 to 35.72+α, range of ±0.5
Actually measured a: 10.22 to 10.93, range of ±1%
Actually measured b: 3.686 to 3.922, range of ±1%
Actually measured c: 10.67 to 11.49, range of ±1%
Actually measured V: 417.0 to 475.1, range of ±1%

### 2-2. Confirmation of Oxygen Desorption Temperature and Hydrogen Consumption (Namely, Oxygen Desorption Amount) Under Reducing Atmosphere

The products of Examples 1, 13 and Comparative Example 3 were each subjected to a hydrogen temperature-programmed reduction (H₂TPR). The measurement device and the measurement conditions are described below.
Measurement device: BELCAT A (manufactured by MicrotracBEL Corp.)

The measurement conditions are described below.
Pretreatment condition: The product (about 50 mg) was introduced into a sample tube, and then the temperature was increased to 500° C. under a 20% O₂/He flow at 30 mL/minute. After the pretreatment for 10 minutes, the product was cooled.
Measurement condition: After replacing with Ar, the temperature was increased while heating at 10° C./minute under a 5% H₂/Ar flow at 30 mL/minute, and hydrogen (H₂) consumption was analyzed. The analysis was performed with a TCD, and desiccant was placed on the front stage of the TCD to trap the generated water.

The products of Examples 1 and 13 and Comparative Example 3 on which Pd is supported were also subjected to H₂TPR. The Pd supporting condition is described below.
Pd supporting condition (Example 1 and Comparative Example 3): 30 mL of distilled water was put in a 100 mL beaker, and Pd(NO₃)₂ was added such that Pd was 1 weight % relative to the product, stirred and dissolved at room temperature, and then heated after the product was added, and evaporated to dryness. The obtained solid was dried at 120° C. overnight, and then pulverized in a mortar, and fired at 500° C. for 3 hours to obtain a product supporting Pd.

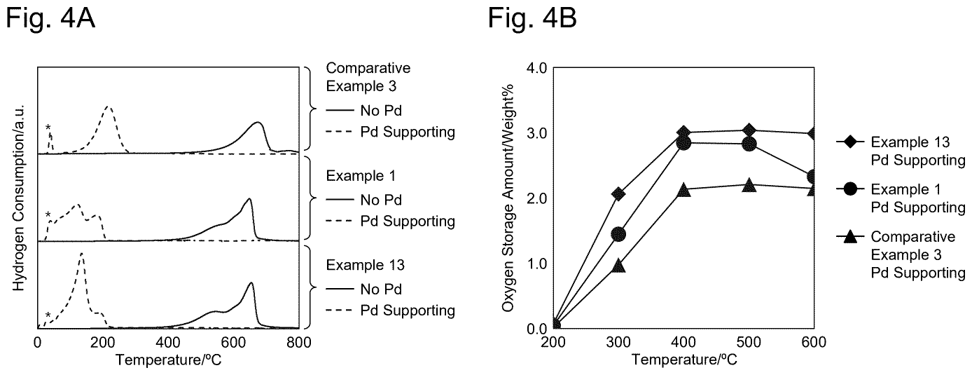

FIG. 4A illustrates the H₂TPR results of the products of Examples 1 and 13 and Comparative Example 3 before and after Pd supporting. The peaks (*) appearing at low temperatures in the products after Pd supporting in FIG. 4A are considered to be due to the reduction of the supported Pd. It was found that, in the products not supporting Pd, peaks of hydrogen consumption appeared at a lower temperature and oxygen was released at a lower temperature in Examples 1 and 13 than in Comparative Example 3. It was found that while supporting Pd caused the peaks of hydrogen consumption to shift to the lower-temperature side in any of the products, the peaks of hydrogen consumption still appeared on the lower-temperature side and oxygen was released at a lower temperature in Examples 1 and 13 than in Comparative Example 3.

Subsequently, for the H₂TPR results of the products of Examples 1 and 13 and Comparative Example 3 before and after Pd supporting, an oxygen storage amount was determined from the total hydrogen consumption (however, in the case of Pd supporting, Pd-derived hydrogen consumption was excluded). Table 5 illustrates the oxygen storage amount of the products of Examples 1 and 13 and Comparative Example 3 before and after Pd supporting.

TABLE 5
Oxygen Storage Amount Obtained from H2TPR Result

Oxygen Storage
Amount/Weight %

| | | No Pd | Pd Supporting |
|---|---|---|---|
| Example 1 | Ce₂TiO₅ | 2.9 | 3.1 |
| Comparative | Ce₂Zr₂O₇ | 2.4 | 2.3 |
| Example 3 | | | |
| Example 13 | Ce₂Ti_{0.8}Al_{0.2}O_{5.9} | 3.3 | 3.3 |

From Table 5, it was found that regardless of whether Pd is supported or not, Example 1 exhibits the oxygen storage amount larger than that of Comparative Example 3, and Example 13 exhibits the oxygen storage amount further larger than that of Comparative Example 3.

### 2-3. OSC (Oxygen Storage Amount) Measurement at Each Temperature

For each of the products supporting 1 weight % of Pd of Examples 1, 3, 4, 13, 19, 20, 26, and 27 and Comparative Example 3, the oxygen storage amount at each temperature was evaluated.

Pd supporting conditions are described below.
Pd supporting condition: 30 mL of distilled water was put in a 100 mL beaker, and Pd(NO₃)₂ was added such that Pd was 1 weight % relative to the product, stirred and dissolved at room temperature, and then heated after the product was added, and evaporated to dryness while being stirred. The obtained solid was dried at 120° C. overnight, and then pulverized in a mortar, and fired at 500° C. for 2 hours to obtain a product supporting Pd.

The measurement device and the measurement condition are described below.
Measurement device: Fixed-bed flow reactor equipped with FT-IR analyzer (manufactured by BEST INSTRUMENTS CO., Ltd.)
Pelletization condition: The products of Example 1 and Comparative Example 3, on which Pd was supported, were compacted by a cold isostatic pressing method under a pressure of 196 kN, then, the resulting molded bodies were pulverized and sieved, and the evaluation was carried out using 2 g of the obtained pellets.
Preprocessing condition: 5% O₂/N₂ was flowed at 200° C. for 5 minutes at 10 L/minute.
Measurement condition: The oxygen storage capacity was measured at 200° C., 300° C., 400° C., 500° C., and 600° C. The flow rate was constantly 10 L/minute, a cycle of 1% O₂/N₂ for 2 minutes, N₂ for 20 seconds, 2% CO/N₂ for 2 minutes, and N₂ for 20 seconds was repeated six times at each temperature, and a value obtained by integrating the CO₂ amount of the second to fifth cycles detected during flowing CO, dividing the product by 4, and further dividing the quotient by the sample amount of 2 g was determined as the oxygen storage amount.

FIG. 4B illustrates the oxygen storage amounts at each temperature of Examples 1 and 13 and Comparative Example 3 on which Pd is supported. From FIG. 4B, it was found that at every temperature at which the measurement was performed, Example 1 (Ce₂TiO₆-type) and Example 13 (Ce₂TiO₆-type Ce₂Ti_{0.8}Al_{0.2}O_{5.9}) exceeded Comparative Example 3 (pyrochlore-type) in the oxygen storage amount.

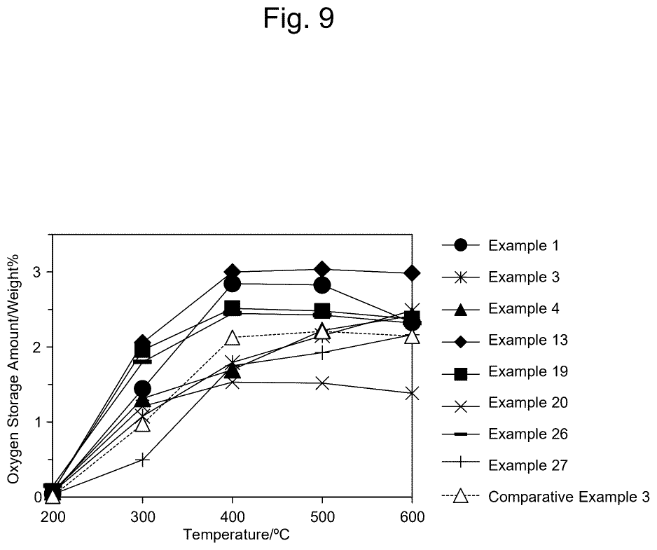

FIG. 9 illustrates the oxygen storage amounts at each temperature of Examples 1, 3, 4, 13, 19, 20, 26, and 27 and Comparative Example 3 on which Pd is supported. From FIG. 9, it was found that Examples 1, 13, 19, and 26 supporting Pd exceeded Comparative Example 3 supporting Pd in the oxygen storage amount at every temperature at which the measurement was performed. Furthermore, it was found that Examples 3, 4, and 20 supporting Pd exceeded Comparative Example 3 supporting Pd in the oxygen storage amount at 300° C. Additionally, it was found that Example 27 supporting Pd exceeded Comparative Example 3 supporting Pd in the oxygen storage amount at 600° C.

### 2-4. Confirmation of Weight Change in Oxidizing Atmosphere (Oxygen Storage Capacity)

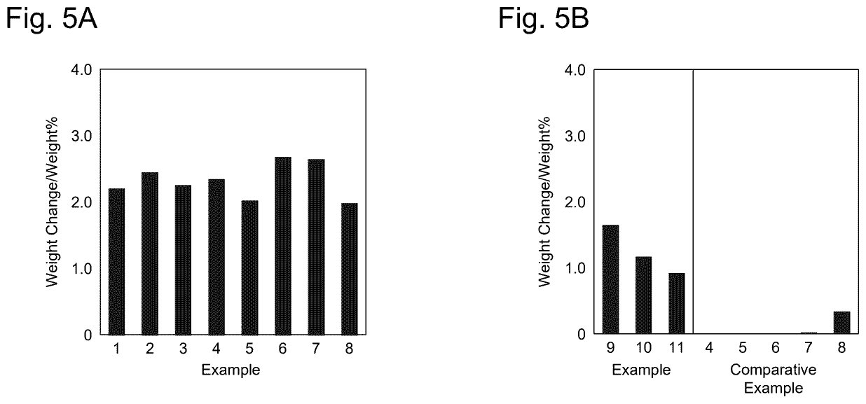

The products supporting Pd of Examples 1 to 11 and Comparative Examples 4 to 8 were reduced under 10% H₂/Ar flow at 500° C. for 6 hours and oxidized in the air at 500° C. for 2 hours, and thus the weight change was determined. FIG. 5A illustrates the weight change in Examples 1 to 8, and FIG. 5B illustrates the weight change in Examples 9 to 11 and Comparative Examples 4 to 8. The products containing Ce of Examples 1 to 11 exhibited the remarkable weight change due to oxidation, and were confirmed to have the oxygen storage capacity. Meanwhile, the products containing Ce in the form of CeO₂ of Comparative Examples 4 to 6 did not exhibit the remarkable weight change due to oxidation. The products containing the rare-earth element other than Ce of Comparative Examples 7 and 8 did not exhibit the remarkable weight change due to oxidation. From this result, it was found that the compound having the Ce₂TiO₆-type crystalline structure containing Ce has the excellent oxygen storage capacity.

### 2-5. Confirmation of Change in Crystalline Structure Due to Oxidation and Reduction

For the product of Example 1, the crystalline structure in the reduced state was confirmed.

The reduction device and the reduction condition are described below.
Reduction device: Fixed-bed flow reactor
Pelletization condition: The product of Example 1 was compacted by a cold isostatic pressing method under a pressure of 196 kN, then, the resulting molded body was pulverized and sieved, and an experiment was carried out using 1 g of the obtained pellet.
Reduction condition: 5% H₂/N₂ was flowed at 750° C. for 30 minutes at 10 L/minute to reduce the pellet. The pellet was cooled to room temperature, then put in a Lamizip pouch filled with Ar, and left in a refrigerator for one hour with a hole made at an end portion of the Lamizip pouch to oxidize only the outermost surface of the pellet.

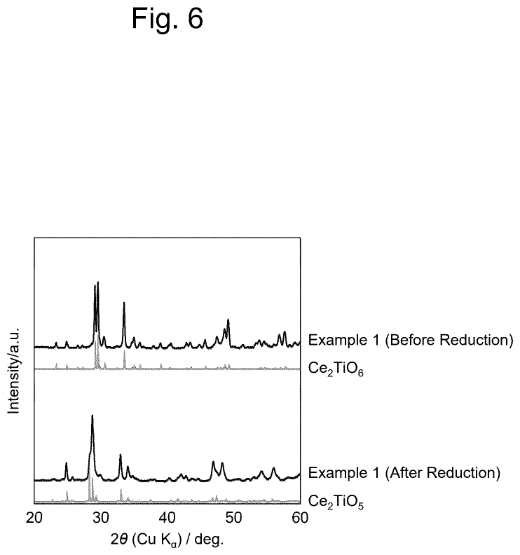

FIG. 6 illustrates X-ray diffraction patterns of the product of Example 1 before and after reduction. For Ce₂TiO₆ and Y₂TiO₅-type Ce₂TiO₅, X-ray diffraction patterns expected from the crystalline structures were calculated, and compared with the X-ray diffraction patterns before and after reduction. The product of Example 1 after reduction exhibited the X-ray diffraction pattern similar to that of Y₂TiO₅-type Ce₂TiO₅. From this result, it was found that the oxygen amount in the product increases and decreases due to the change between Ce₂TiO₆ in the oxidized state and Ce₂TiO_{6-δ} having the crystalline structure close to the Y₂TiO₅-type in the reduced state, thereby expressing the oxygen storage capacity.

Note that, it was found that since Ce₂TiO_{6-δ} immediately after reducing the product of Example 1 is extremely easily oxidized, and the heat generation due to oxidation causes further oxidation, the reduced pellet directly exposed in the air at room temperature changes to Ce₂TiO₆.

### 2-6. Discussion on Oxygen Storage Mechanism (Relationship Between Crystalline Structure and Oxygen Storage Capacity)

FIG. 1A illustrates the crystalline structure of La₂TiO₅, and FIG. 1B illustrates the crystalline structure of Ce₂TiO₆. An oxide containing trivalent rare-earth metal ions, such as La₂TiO₅, and tetravalent titanium ions (Ti⁴⁺) has the Y₂TiO₅-type crystalline structure. At O²⁻ conduction in La₂TiO₅, the O²⁻ conduction is considered to occur in the b-axis direction of FIG. 1A, and in a computational study, it is expected that when excess O²⁻ is present in La₂TiO₅, it approaches Ti⁴⁺ of TiO₅ quadrangular pyramid, positions forming a TiO₆ octahedron are stable, and a barrier energy for the O²⁻ conduction is low (E. Kendrick et al., Solid State Ionics, pages 179, 819 to 822, 2008, “A computational study of oxide ion migration and water incorporation in the cuspidine system, La₄(Ti₂O₈)O₂”). As a result of the crystalline structure analysis, Ce₂TiO₆ is considered to be a substance having a Ce₂TiO₆-type structure that is a novel crystalline structure in which, although similar to La₂TiO₅, La³⁺ is replaced with Ce⁴⁺ and excess O²⁻ is incorporated for charge compensation. It is presumed that the excess O²⁻ approaches Ti⁴⁺ of TiO₅ quadrangular pyramid, and is present at positions forming a TiO₆ octahedron. It is considered that when Ce₂TiO₆ is reduced, Ce₄₊ is converted to Ce³⁺, and excess O²⁻ is released as oxygen (O₂) for charge compensation, thus being converted from Ce₂TiO₆-type to Ce₂TiO_{6-δ} having the crystalline structure close to Y₂TiO₅-type, thereby exhibiting the oxygen storage capacity.

It is presumed that among rare-earth metal elements, those containing Ce for which the tetravalent ion is stable have the Ce₂TiO₆-type structure, and O²⁻ deficiency may occur depending on the composition. For the rare-earth metal elements, the trivalent ion is stable, and in the oxides of one aspect of the present disclosure, Y is present in the state of Y³⁺, La is present in the state of La³⁺, and Sm is present in the state of Sm³⁺. For Ce, the trivalent and tetravalent ions are stable, and the tetravalent ion of Ce is most stable among the rare-earth metal elements, therefore, in one aspect of the present disclosure, Ce is obtained in the state of Ce⁴⁺ after the synthesis, and is converted to Ce³⁺ in the reducing atmosphere, thus providing the oxygen storage capacity. While the trivalent and tetravalent ions are stable also for Pr, the tetravalent ion is unstable compared with Ce, and Pr is present in the state of approximately Pr³⁺ and less likely to be oxidized to Pr⁴⁺ in the oxides of one aspect of the present disclosure, therefore, Pr hardly contributes to the oxygen storage amount.

When the composition after the synthesis is assumed to be Ce₂₋ₓAₓTiO_{6-y} (A=Y, La, Pr, or Sm), since the increase of x causes Ce⁴⁺ to be replaced with A³⁺, and O²⁻ deficiency is necessary for the charge compensation, the composition, such as Ce_{1.5}La_{0.5}TiO_{5.75}, results.

2-7. Relationship between Firing in Reducing Atmosphere and Product In the method for producing the oxide in one aspect of the present disclosure, the precursor is fired in the reducing atmosphere. Since a mixture of CeO₂ and TiO₂ is obtained by firing the precursor containing Ce⁴⁺ and Ti⁴⁺ in the oxidizing atmosphere, Ce₂TiO₆ is considered to be a metastable phase. It is presumed that to obtain Ce₂TiO₆, firing needs to be performed once in the reducing atmosphere to reduce Ce⁴⁺ to Ce³⁺, thereby passing through Ce₂TiO₅ that is an oxide containing Ce³⁺ and Ti⁴⁺. In Examples, the precursor oxide is mixed with activated carbon, and a large excess of the activated carbon is covered thereon and fired. It is considered that O₂ in the air is consumed due to incomplete combustion of the activated carbon and CO is generated, and thus the reducing atmosphere is formed. It is presumed that in the reducing atmosphere in which CO is present, the most part of Ce is converted to Ce³⁺ to form Ce₂TiO₅. During the cooling process after the firing, when the activated carbon ceases to combust, the atmosphere is no longer reducing, Ce₂TiO₅ reacts with O₂ in the air at a temperature at which Ce³⁺ and Ti⁴⁺ are immobile, and Ce³⁺ is oxidized to Ce⁴⁺, thereby forming Ce₂TiO₆ as the product.

All publications, patents and patent applications cited in the present description are herein incorporated by reference as they are.

What is claimed is:

1. A composite oxide having a composition represented by a general formula Ce_{2-w-x′}A_{w}A′_{x′}B_{1-y′-z}B′_{y′}B″_{z}O_{6-w/2-x′-y′/2-z},
wherein in the formula:
A is one or more elements selected from rare-earth metal elements excluding Ce;
A′ is one or more elements selected from alkaline earth metal elements;
B is one or more elements selected from a group consisting of Ti and Group 14 elements;
B′ is one or more elements selected from a group consisting of Group 13 elements;
B″ is one or more elements selected from a group consisting of Group 12 elements;
2−w−x′, w, x′, 1−y′−z, y′, z, and 6−w/2−x′−y′/2−z are mole ratios of Ce, A, A′, B, B′, B″, and O, respectively when B+B′+B″ is assumed to be 1;
w, x′, y′, and z satisfy 0≤w<2, 0≤x′≤0.5, 0≤y′≤1, 0≤z≤0.5, respectively; and
w+x′ satisfies 0≤w+x′<2, and y′+z satisfies 0≤y′+z≤1.

2. The composite oxide according to claim 1,
wherein in an X-ray diffraction pattern in which a range of 2θ measured using CuKα as an X-ray source is 5 deg. to 90 deg., an angle of a maximum X-ray diffraction peak exhibiting a highest intensity is within the 2θ range of 27 deg. to 31 deg., and when a peak intensity of the maximum X-ray diffraction peak is represented by Iₐ, and a maximum peak intensity among the X-ray diffraction peaks within the 20 range of 32 deg. to 37 deg. is represented by I_{b}, I_{b}/Iₐ satisfies 0.15≤I_{b}/Iₐ≤0.85.

3. The composite oxide according to claim 2,
wherein in a crystalline structure obtained from an X-ray diffraction after heating at 500° C. for 6 hours in air, when a space group is Pnma and a Z-value is 4, lattice constants a, b, and c, and a lattice volume V satisfy 10.1 Å≤a≤11.1 Å, 3.64 Å≤b≤3.97 Å, 10.5 Å≤c≤11.7 Å, and 412 Å³≤V≤480 Å³, respectively (where numerical values are mutually exchangeable between the lattice constants a, b, and c).

4. The composite oxide according to claim 1,
wherein B includes Ti, and 1−y′−z satisfies 0≤1−y′−z.

5. The composite oxide according to claim 1,
wherein B′ includes Al, and y′ satisfies 0<y′.

6. The composite oxide according to claim 1,
wherein w+x′+y′+z satisfies 0<w+x′+y′+z.

7. An oxygen storage material comprising the composite oxide according to claim 1.
